(19) United States
(12) Patent Application Publication
(10) Pub. No.: US 2004/0012872 A1
(43) Pub. Date: Jan. 22, 2004

(54) Multiphoton absorption method using patterned light

(76) Inventors: Patrick R Fleming, Lake Elmo, MN (US); Robert J. DeVoe, Oakdale, MN (US); Nicholas A Stacey, Austin, TX (US); Catherine A Leatherdale, St Paul, MN (US); Robert D. DeMaster, Afton, MN (US); Todd A. Ballen, St. Paul, MN (US); Jeffrey M Florczak, Austin, TX (US)

Correspondence Address: Lucy C Weiss, Office of Intellectual Property Counsel, 3M Innovative Properties Company, PO Box 33427, St Paul, MN, 55133-3427, US

(21) Appl. No.: 10/297,963

(22) PCT Filed: Jun. 14, 2001
(86) PCT No.: PCT/US01/19126

(51) Int. Cl. G02B 5/22

(52) U.S. Cl. 359/885

(57) ABSTRACT

Methods for producing a region of at least partially reacted material in a photoreactive composition and apparatus. The methods include: providing a photoreactive composition; providing a source of sufficient light for simultaneous absorption of at least two photons by the photoreactive composition; providing an exposure system capable of inducing image-wise multiphoton absorption; generating a non-random three-dimensional pattern of light by means of the exposure system; and exposing the photoreactive composition to the three-dimensional pattern of light generated by the exposure system to at least partially react a portion of the material in correspondence with the non-random three-dimensional pattern of light incident thereon.

### STATEMENT OF PRIORITY

This application claims the priority of U.S. Provisional Application No. 60/211,675 filed Jun. 15, 2000, the contents of which are hereby incorporated by reference.

### FIELD

This invention relates to multiphoton absorption methods and patterns for preparing polymeric three-dimensional structures therefrom.

### BACKGROUND

Molecular two-photon absorption was predicted by Goppert-Mayer in 1931. Upon the invention of pulsed ruby lasers in 1960, experimental observation of two-photon absorption became a reality. Subsequently, two-photon excitation has found application in biology and optical data storage, as well as in other fields.

There are two key differences between two-photon induced photoprocesses and single-photon induced processes. Whereas single-photon absorption scales linearly with the intensity of the incident radiation, two-photon absorption scales quadratically. Higher-order absorptions scale with a related higher power of incident intensity. As a result, it is possible to perform multiphoton processes with three-dimensional spatial resolution. Also, because multiphoton processes involve the simultaneous absorption of two or more photons, the absorbing chromophore is excited with a number of photons whose total energy equals the energy of an excited state of a multiphoton photosensitizer, even though each photon individually has insufficient energy to excite the chromophore. Because the exciting light is not attenuated by single-photon absorption within a curable matrix or material, it is possible to selectively excite molecules at a greater depth within a material than would be possible via single-photon excitation by use of a beam that is focused to that depth in the material. These two phenomena also apply, for example, to excitation within tissue or other biological materials. Such work has been limited, however, to slow writing speeds and high laser powers. Thus, there is a need for methods of improving the throughput and efficiency of multiphoton absorption systems. In multiphoton lithography or stereolithography, the nonlinear scaling of absorption with intensity can lead to the ability to write features having a size that is less than the diffraction limit of the light as well as the ability to write features in three dimensions, which is also of interest for holography.

### BRIEF DESCRIPTION OF THE DRAWINGS

FIG. 1a is an illustration of a micro-optical element exposure system of the present invention.

FIG. 1b is an illustration of an alternative embodiment of a micro-optical element exposure system having microlenses with varying focal lengths.

FIG. 1c illustrates an alternative embodiment including an array of aspheric, off-axis microlenses.

FIG. 2 illustrates a diffractive optical element exposure system of the present invention in which a beamsplitting diffractive optical element (DOE) is utilized.

FIG. 3 illustrates an alternative embodiment of a diffractive optical element exposure system in which a wavefront transformation DOE is utilized.

FIG. 4 is an exposure system that combines a collimated plane wave and a diverging spherical wave to produce interference pattern in a photoreactive composition.

FIG. 5 illustrates an embodiment of an exposure system that includes a combination of three or more beams having the same or substantially different wavefronts to cause multiphoton absorption by selected regions in a photoreactive composition.

FIG. 6 is an illustration of a system that includes an array of adjustable planar mirrors used to steer beams from an array of microlenses into a photoreactive composition.

FIG. 7 is a scanning electron micrograph of the structures that result under the test conditions of Example 2.

FIG. 8 illustrates an exposure system utilized for Example 3 that includes an array of diffractive lenses.

FIG. 9 is a scanning electron micrograph of a structure that resulted under the imaging conditions of Example 3.

FIG. 10 is a scanning electron micrograph of a structure that resulted under the imaging conditions of Example 3.

FIG. 11 is an optical micrograph of a structure that resulted under the imaging conditions of Example 4.

FIG. 12 is an optical micrograph of a refractive index contrast image.

### SUMMARY

The present invention provides various methods and apparatus for producing a region of at least partially reacted material in a photoreactive composition. In one embodiment, a method includes: providing a photoreactive composition; providing a source of sufficient light for simultaneous absorption of at least two photons by the photoreactive composition; providing an exposure system comprising at least one diffractive optical element (preferably, the diffractive optical element is capable of beamsplitting, wavefront transformation, or both), wherein the exposure system is capable of inducing image-wise multiphoton absorption; generating a non-random three-dimensional pattern of light by means of the exposure system; and exposing the photoreactive composition to the three-dimensional pattern of light generated by the exposure system to at least partially react a portion of the material in correspondence with the non-random three-dimensional pattern of light incident thereon. Being “in correspondence with” does not require the reacted material to form an exact copy of the three-dimensional pattern of light, although an exact copy is possible.

In another embodiment, a method for producing a region of at least partially reacted material in a photoreactive composition includes: providing a photoreactive composition; providing a source of sufficient light for simultaneous absorption of at least two photons by the photoreactive composition; providing an exposure system comprising at least one array of refractive micro-optical elements, wherein the exposure system is capable of inducing image-wise multiphoton absorption; generating a non-random three-dimensional pattern of light by means of the exposure system; and exposing the photoreactive composition to the three-dimensional pattern of light generated by the exposure system to at least partially react a portion of the material in correspondence with the non-random three-dimensional pattern of light incident thereon.

In yet another embodiment, a method includes: providing a photoreactive composition; providing a source of sufficient light for simultaneous absorption of at least two photons by the photoreactive composition; providing an exposure system capable of inducing image-wise multiphoton absorption, wherein the exposure system includes a first beam of light having a first wavefront shape; and a second beam of light having a second wavefront shape, wherein the first wavefront shape is substantially different from the second wavefront shape. The method includes generating a non-random three-dimensional pattern of light by means of the exposure system using optical interference between the first beam of light and the second beam of light; and exposing the photoreactive composition to the three-dimensional pattern of light generated by the exposure system to at least partially react a portion of the material in correspondence with the non-random three-dimensional pattern of light incident thereon.

In another embodiment, a method for producing a region of at least partially reacted material in a photoreactive composition includes: providing a photoreactive composition; providing a source of sufficient light for simultaneous absorption of at least two photons by the photoreactive composition; providing an exposure system capable of inducing image-wise multiphoton absorption, wherein the exposure system includes three or more light beams, wherein each light beam of the three or more light beams includes a wavefront having a shape, and further wherein each light beam of the three or more light beams has a wavefront shape that is the same or substantially different from the wavefront shape of the other light beams. The method includes generating a non-random three-dimensional pattern of light by means of the exposure system using optical interference from the three or more light beams; and exposing the photoreactive composition to the three-dimensional pattern of light generated by the exposure system to at least partially react a portion of the material in correspondence with the non-random three-dimensional pattern of light incident thereon.

Various systems are provided for carrying out the various methods of the present invention. In one embodiment, there is provided an apparatus for reacting a photoreactive composition that includes: a photoreactive composition; a source of sufficient light for simultaneous absorption of at least two photons by the photoreactive composition; an exposure system that includes at least one diffractive optical element (preferably, the diffractive optical element is capable of beamsplitting, wavefront transformation, or both), wherein the exposure system is capable of inducing image-wise multiphoton absorption, wherein the exposure system is capable of generating a non-random three-dimensional pattern of light, and further wherein the exposure system is capable of at least partially reacting a portion of the material in correspondence with the non-random three-dimensional pattern of light.

In another embodiment, an apparatus for reacting a photoreactive composition includes: a photoreactive composition; a source of sufficient light for simultaneous absorption of at least two photons by the photoreactive composition; an exposure system that includes at least one array of refractive micro-optical elements, wherein the exposure system is capable of inducing image-wise multiphoton absorption; wherein the exposure system is capable of generating a non-random three-dimensional pattern of light, and further wherein the exposure system is capable of at least partially reacting a portion of the material in correspondence with the non-random three-dimensional pattern of light.

In yet another embodiment, the present invention provides an apparatus for reacting a photoreactive composition that includes: a photoreactive composition; a source of sufficient light for simultaneous absorption of at least two photons by the photoreactive composition; an exposure system that includes a first beam of light including a first wavefront shape and a second beam of light including a second wavefront shape, wherein the first wavefront shape is substantially different than the second wavefront shape, wherein the exposure system is capable of inducing image-wise multiphoton absorption, wherein the exposure system is capable of generating a non-random three-dimensional pattern of light, and further wherein the exposure system is capable of at least partially reacting a portion of the material in correspondence with the non-random three-dimensional pattern of light.

In another embodiment, an apparatus for reacting a photoreactive composition includes: a photoreactive composition; a source of sufficient light for simultaneous absorption of at least two photons by the photoreactive composition; an exposure system comprising three or more light beams, wherein each light beam of the three or more light beams includes a wavefront having a shape, wherein each light beam of the three or more light beams has a wavefront shape that is the same or substantially different than the wavefront shape of the other light beams, wherein the exposure system is capable of inducing image-wise multiphoton absorption, wherein the exposure system is capable of generating a non-random three-dimensional pattern of light, and further wherein the exposure system is capable of at least partially reacting a portion of the material in correspondence with the non-random three-dimensional pattern of light.

Preferably, the light source is a pulsed laser and exposing includes pulse irradiating, which is preferably carried out using a near infrared pulsed laser having a pulse length less than about 10 nanoseconds.

Preferably, the photoreactive commotion in includes one or more reactive species, one or more multiphoton photosensitizers, one or more electron donor compounds, and one or more photoinitiators. More preferably, the photoreactive composition includes about 5% to about 99.79% by weight of the at least one reactive species, about 0.01% to about 10% by weight of the at least one multiphoton photosensitizer, up to about 10% by weight of the at least one electron donor compound, and about 0.1% to about 10% by weight of the at least one photoinitiator, based upon the total weight of solids.

Definitions

As used herein:

“multiphoton absorption” means simultaneous absorption of two or more photons to reach a reactive, electronic excited state that is energetically inaccessible by the absorption of a single photon of the same energy;

“simultaneous” means two events that occur within the period of 10⁻¹⁴ second or less;

“electronic excited state” means an electronic state of a molecule that is higher in energy than the molecule's electronic ground state, that is accessible via absorption of electromagnetic radiation, and that has a lifetime greater than 10⁻¹³ second;

“react” means to effect curing (polymerization and/or crosslinking) as well as to effect depolymerization or other reactions;

“optical system” means a system for controlling light, the system including at least one element chosen from refractive optical elements such as lenses, reflective optical elements such as mirrors, and diffractive optical elements such as gratings and computer-generated holograms; optical elements shall also include diffusers, wave guides, and other elements known in the optical arts;

“exposure system” means an optical system plus a light source;

“sufficient light” means light of sufficient intensity and appropriate wavelength to effect multiphoton absorption; “photosensitizer” means a molecule that lowers the energy required to activate a photoinitiator by absorbing light of lower energy than is required by the photoinitiator for activation and interacting with the photoinitiator to produce a photoinitiating species therefrom;

“photochemically effective amounts” (of the components of the photoinitiator system) means amounts sufficient to enable the reactive species to undergo at least partial reaction under the selected exposure conditions (as evidenced, for example, by a change in density, viscosity, color, pH, refractive index, or other physical or chemical property);

“transit” means passing light completely through a volume of a photoreactive composition;

“focus” or “focusing” means bringing collimated light to a point or forming an image of an object;

“wavefront” means a surface of constant phase on a propagating electromagnetic field; e.g., light emitted from a point source has a spherical wavefront; and

“substantially different” as applied to two or more wavefronts describes how the coherent electromagnetic beams will interact when combined. If the optical system used to generate the interference pattern is reconfigured so that the beams are collinear (overlap and have parallel propagation directions), the interference pattern formed by the combination of the beams will generate at least one light and one dark interference fringe across the area of interest at the desired image plane. This implies that there exists at least a half-wavelength difference in wavefront between the beams in this region.

### DETAILED DESCRIPTION OF PREFERRED EMBODIMENTS

Common techniques for exposing single-photon photodefinable (e.g., photocurable) materials typically use a light source that floods a large area in concert with a reflective or opaque mask in order to select the area(s) to be exposed. In addition, optical elements can be incorporated into the exposure system to carry out projection lithography that will provide features of micron size. Typically, in these projection systems, the image in the mask is reduced in size, the light at the image plane is collimated, and the light fluence is uniform over the exposed regions. A second common technique is to directly “write” an image using a laser light source, for example, and appropriate optics. In this case the actual pattern resides in a computer file and the image is directly written by a computer-controlled stage and laser system. The laser spot size is reduced by means of an optical element so as to produce the finest features of the pattern.

Multiphoton processes typically require relatively high light fluence with pulse lengths on the order of nanoseconds so as to provide a significant number of photons at the initiation region. The high light fluence may be achieved by focusing a high-energy laser light using a relatively high numerical aperture (NA) lens, e.g., a microscope objective lens. A high NA provides a shallow depth of focus, yielding good z-axis control of the multiphoton absorption process. Three-dimensional objects can be fabricated by moving the laser source precisely in the x-y-z directions to form reacted materials in a desired shape. However, this technique can be slow and the precision of the technique will be limited by the precision of the moving mechanical elements.

Exposure of a large area of multiphoton-absorbing (e.g., curable) material can enable faster fabrication of large objects. It is known that photopolymerization masks featuring projection optics would not have the z-axis focusing capabilities necessary to form complex shapes in three dimensions. The present invention discloses the use of mask configurations wherein the light-transmitting regions include refractive elements, for example, capable of focusing the light so as to provide adequate z-axis definition. As an example, a mask with a focusing feature can be made from a photoresist that is photolithographically defined, then melted to form one or more convex shapes comprising predefined complex refractive structures.

Other fabrication methods (such as photolytic volume expansion of glass, polymer droplet dispensing, mass transport, focused ion-beam milling and other micro-optical fabrication methods known in the art) may also be used to generate the refractive surfaces necessary to provide appropriate z-axis definition.

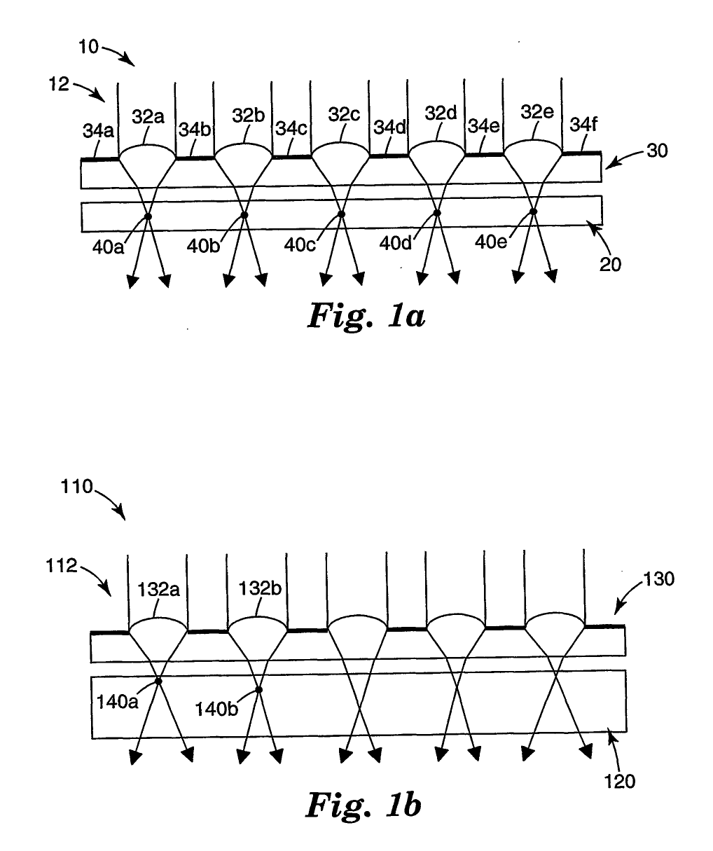

An example of this refractive configuration is shown in FIG. 1a, in which a micro-optical element exposure system 10 of the present invention is illustrated. Herein, a micro-optical element refers to an optical element that has an aperture of 5 mm or less in at least one direction. Micro-optics are usually those optics with apertures less than about 6 mm in diameter. Fibers are often included in this category. See, for example the catalog from Newport Corp. for Irvine Calif.

As depicted in FIG. 1a, micro-optical element exposure system 10 includes a photoreactive composition 20 and a micro-optical element array 30. The micro-optical element array 30 is used to focus incident light 12 into focal points 40a-40e (“focal points 40”) to cause multiphoton absorption within the photoreactive composition 20. The micro-optical element array 30 includes refractive microlenses 32a-32e (“microlenses 32”) and opaque portions 34a-34f (“opaque portions 34”). The opaque portions 34 do not allow transmission of incident light 12 through the micro-optical element array 30 to the photoreactive composition 20. The microlenses 32 refract the incident light 12 and focus it at focal points 40. Moving the photoreactive composition 20 precisely in directions parallel and perpendicular to the direction of illumination allows the simultaneous reacting of several identical structures. The width, depth, and orientation angle of the individual volume elements created within the photoreactive composition 20 that are illuminated by the microlenses 32 can be controlled by appropriate design of the micro-optical element array 30 (e.g., by incorporating off-axis, aspheric, and anamorphic surfaces).

Likewise, it is possible to extend the planar exposure configuration of FIG. 1a into three dimensions by changing the focal length of the individual microlenses 32 in the micro-optical element array 30. Furthermore, the micro-optical elements do not need to be arranged in a regular array or have unity fill factor.

An example of the micro-optical element exposure system 10 having microlenses 32 with varying focal lengths is illustrated as an alternative embodiment in FIG. 1b. In FIG. 1b, microlenses 132 of micro-optical element array 130 have a variety of focal lengths to focus the incident light 112 at focal points 140 at varying depths in the photoreactive composition 120. For example, microlens 132a has a shorter focal length than microlens 132b and thus focuses the incident light 112 at a focal point 140a that is nearer the surface of photoreactive composition 120 than focal point 140b, which is the focal point for microlens 132b.

Simultaneous reacting (e.g., curing) of a complex three-dimensional structure is also possible by incorporating beam-steering into the microlens array. The three-dimensional structure is formed by using the light focused from each microlens to react separate regions that are in physical contact, but that do not overlap. FIG. 1c illustrates this concept as an alternative embodiment of the present invention. In FIG. 1c, an array 230 of aspheric, off-axis microlenses 232 is depicted. Each of the microlenses 232 has a different focal length and the array is used to react with (e.g., cure) multiple non-overlapping regions simultaneously at focal points 240a-240e.

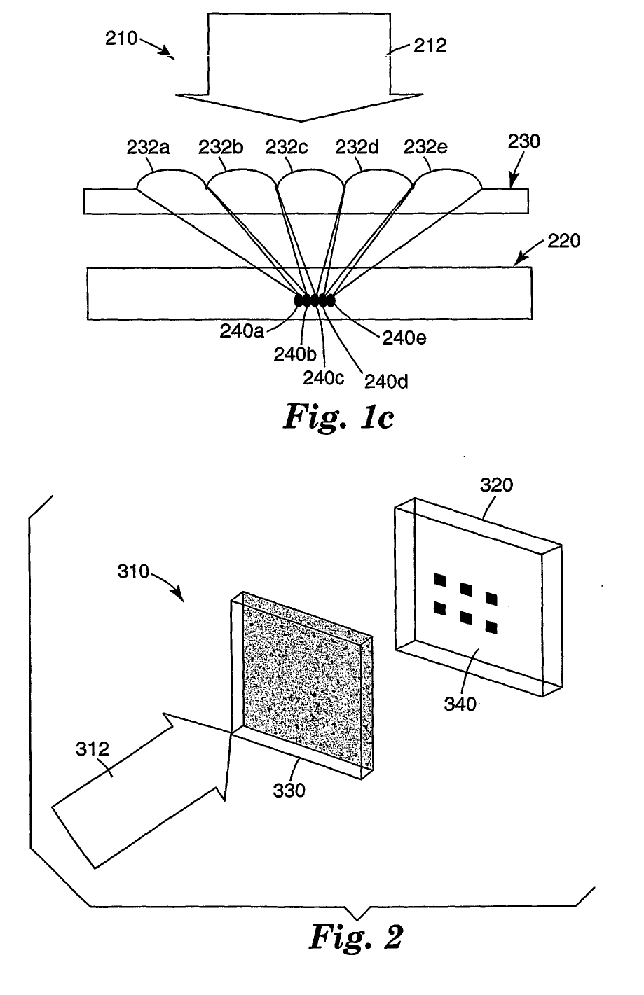

A preferred method of the present invention includes the use of a diffractive optical element (DOE) that will focus high energy light as if it came from a high numerical aperture objective lens, but over a large area in three dimensions. The functions of DOEs can be further divided into two categories: producing discrete arrays of illuminated regions (beamsplitting) and producing continuous illuminated regions of specified shape (wavefront transformation). A single DOE can perform both functions. The optical effect of beamsplitting elements (shown in FIG. 2) resembles that of the refractive microlens case—a series of focal spots is produced.

In FIG. 2, a diffractive optical element exposure system 310 includes a photoreactive composition 320 and a diffractive optical element 330. The DOE 330 diffracts a beam of incident light 312 into focal points 340 in the photoreactive composition 320. As is the case with refractive microlenses (see, e.g., FIGS. 1a-1c), the DOE 330 creates discrete focal points 340.

An important distinction can be made between the way that available light is used in refractive elements and diffractive elements. For refractive elements, only the light incident on each microlens is brought to a focus within the photoreactive composition (i.e., light between microlenses is unfocused or reflected and does not contribute to reacting (e.g., curing)). This is illustrated in FIG. 1a, where light 12 that is incident on opaque regions 34a-34e is not refracted to focal points within the photoreactive composition 20. For the diffractive case, all of the light incident upon the DOE (if the element operates at high efficiency) is directed into the desired array pattern (see, e.g., FIG. 2). In addition, the effective NA of a DOE can be higher than the NA of the individual microlenses. The larger NA gives a shallower depth of focus and provides better z-axis resolution.

In addition, the focal point of a microlens has a specific form determined by diffraction from the defining aperture (e.g., a circular lens produces a circular Airy disk diffraction pattern). The beamsplitting diffractive element, on the other hand, can be designed to produce “focal spots” having a more general shape, e.g., square, rectangular, etc. Wavefront transformation diffractive optical elements, on the other hand, convert the incident light field into a more general, semi-continuous pattern at the desired location.

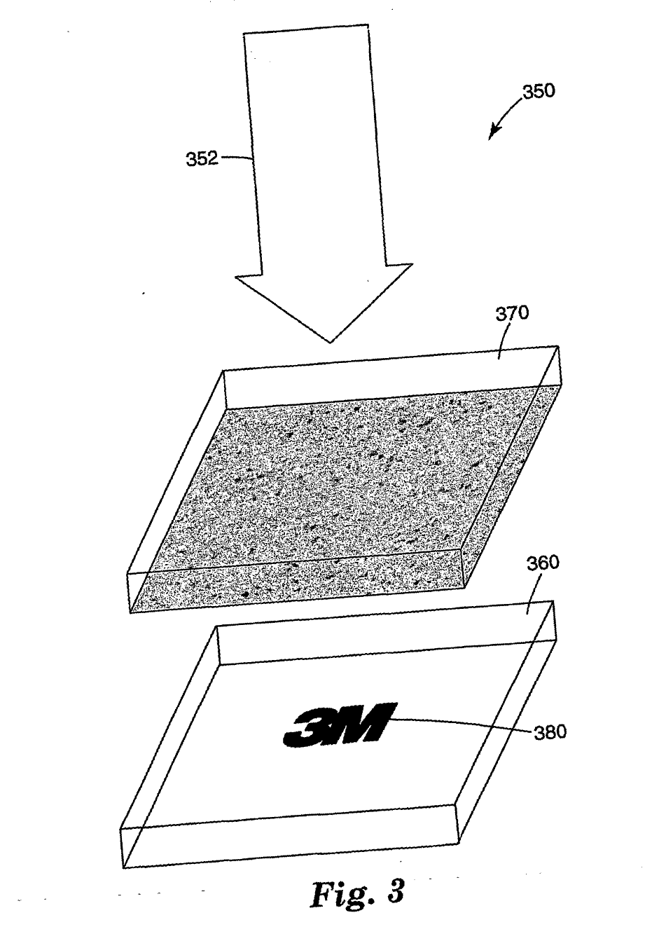

FIG. 3 is an illustration of an alternative embodiment of the present invention in which a wavefront transformation DOE is utilized. As depicted, a diffractive optical element exposure system 350 includes a wavefront transformation DOE 370 and a photoreactive composition 360. Incident light 352 is diffracted by DOE 370 into a non-random three dimensional pattern 380 that is semi-continuous.

Both types of DOEs (beamsplitting and wavefront transforming) are used to concentrate light from a large-area incident beam into a smaller spatial region to cause reacting (e.g., curing) of a photoreactive composition. In cases where the diffractive element is operating similar to one or more refractive lenses (i.e., one or more discrete focal spots of small size are generated) the resulting focal patterns may have depth of focus properties similar to those achieved by refractive lenses (depending upon the DOE design method). When a complex light pattern is generated through wavefront transformation, the behavior of the light field in locations away from the image plane becomes more complicated. For a particular case (such as a long, narrow pattern) the depth of focus resulting from the DOE may be different in the two directions perpendicular to the optical axis. This property can be used to advantage in the formation of certain structures.

One possible method that can be used to design a DOE (in the paraxial case) involves an iterative Fourier transform algorithm that simulates the light field propagation between the plane of the diffractive element and the image plane. The desired light field amplitude distribution at the image plane and the fabrication restrictions of the diffractive element serve as bounds to cause the convergence of the design of the diffractive element. (Other paraxial and non-paraxial methods useful for designing DOEs are also known in the art.) In general, the complexity and resolution of a particular image formed by the diffractive element (as well as the efficiency of the diffractive element) are controlled by the method used to fabricate the diffractive element. The optical phase function calculated by the above process is then encoded in the DOE, typically as a surface-relief profile (though other methods may also be used).

The exact construction of the DOE has a significant effect on the available optical efficiency (defined as the percentage of incident light that is directed into the desired area or direction). A DOE is commonly constructed as a surface relief pattern in a transparent or reflective material having a multi-step profile that approximates the continuous profile that resulted from the design process. The efficiency of the DOE increases with the number of levels that are used in the approximation process; continuous profiles have the highest efficiency. The overall efficiency also depends upon whether the calculated optical phase function used to form the DOE is restricted to be separable in the in-plane coordinate system; non-separable phase functions can have significantly higher diffraction efficiency. The smallest horizontal feature that can be made in the DOE fabrication process limits the effective numerical aperture, which controls the smallest feature that can be resolved in the image plane of the DOE.

Diffractive elements can be fabricated by known procedures, such as forming and recording patterns of interference of coherent (e.g., laser) light, also known as holograms, or by construction of a surface-relief profile. The desired phase profile can be formed, e.g., in the surface of a material either by selective chemical or physical etching, direct writing of a developable photopolymer (using an electron beam or laser), or through laser ablation. In all cases, the phase function recorded in the diffractive element alters the phase information of an incident light wave and redirects the wave in a predetermined direction.

Previous examples of multiphoton absorption as a holographic fabrication method have been published (see, e.g., T. J. Bunning, et al., Chem. Mater., 12, 2842 and C. Diamond, et al., Opt. Express, 6 (3), 64). Interference between two beams having substantially identical wavefront shapes was used in both of these demonstrations to create an interference pattern that reacted (e.g., cured) the photoreactive composition (and resulted in periodic reacted lines). In the first example, two collimated beams (having neither parallel nor antiparallel propagation directions) were incident upon the photoreactive composition. In the second example, the two beams were combined and focused at the sample surface using separate parts of the same lens. In both cases the two beams had virtually identical wavefronts and differed only in their propagation direction.

The present invention discloses the combination of two beams having substantially different wavefronts to cause multiphoton absorption in selected regions. The energy in the individual beams is insufficient to cause multiphoton absorption; however, the energy at the interference maxima is sufficient to cause multiphoton absorption by the photoreactive composition. The use of two substantially different beams allows interference patters to be produced that do not constitute a regular array.

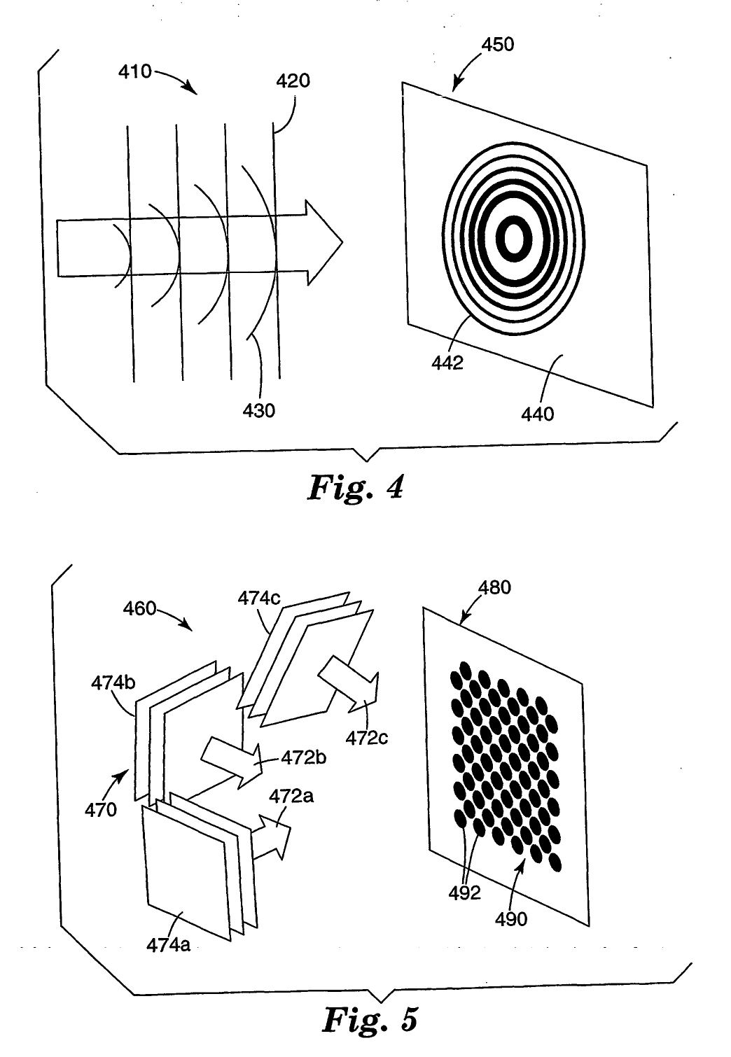

One embodiment of this construction is illustrated in FIG. 4. Here, an exposure system 410 combines a collimated plane wave 420 and a diverging spherical wave 430 to produce interference pattern 440 in a photoreactive composition 450. The interference pattern 440 formed by the combination of these two beams 420 and 430 from a continuous-wave light source is a series of concentric rings 442. For the short pulses used in multiphoton absorption, precise matching of the pathlength of the two beams allows the overlap of the pulses to form selected regions of the interference pattern. By careful adjustment of the pathlength of one beam with respect to the other, it is possible to react different portions of the interference pattern with successive laser pulses. Although this embodiment includes the simple case of a planar and spherical wave combined together, it is understood that a variety of optical elements may be placed into either of the beams to precisely shape each wavefront and to create reacted regions in correspondence with portions of interference patterns having curved lines and/or lines of varying periodicity.

The present invention also discloses the combination of three or more beams having the same or substantially different wavefronts to cause multiphoton absorption by selected regions. FIG. 5 is an illustration of one embodiment of this construction. In FIG. 5, an exposure system 460 includes incident light 470, including light beams 472a, 472b, and 472c (“light beams 472”), and photoreactive composition 480. Each of the light beams 472 include collimated plane waves 474 (i.e., plane waves 474a, 474b, and 474c). The plane waves 474 have non-parallel propagation directions. The plane waves 474 are combined to form an interference pattern 490 in the photoreactive composition 480. The interference pattern 490 formed by the combination of these three light beams 472 is an array of intensity maxima in a grid arrangement 492. FIG. 5 shows the intensity maxima 492 that lie within a particular plane; however, interference fringes occur throughout three-dimensions. For the short pulses used in multiphoton absorption, precise matching of the pathlength of the three beams 472 allows the overlap of the pulses to form selected regions of the three-dimensional interference pattern 490. By careful adjustment of each of the beam pathlengths with respect to the others, it is therefore possible to react different portions of the interference pattern 490 with successive laser pulses.

Although this embodiment describes the simple case of three similar plane waves 474 used to generate an interference pattern 490, it is understood that a variety of optical elements may be placed into one or more of the three or more beams 472 to precisely shape each wavefront and to create reacted regions in complex three-dimensional patterns in correspondence with a three-dimensional pattern of light.

The embodiments of multiphoton absorption described above use only static refractive and diffractive optical elements. This invention can be extended by the incorporation of active optical elements into the optical system to allow dynamic control of the light patterns used to react the photoreactive composition.

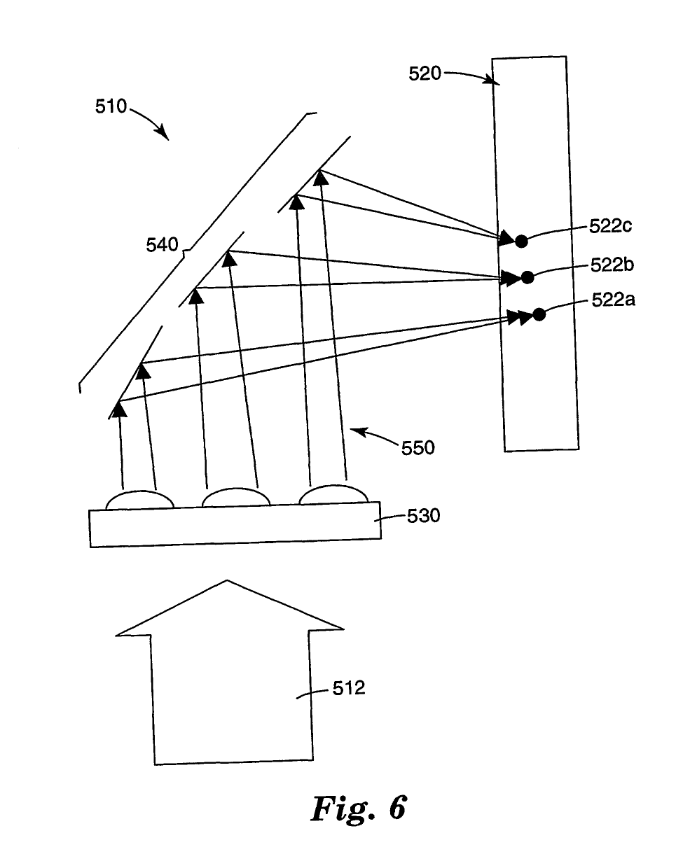

One embodiment of this is shown in FIG. 6, where an array of adjustable planar mirrors 540 are used to steer beams 550 from an array of microlenses 530 into a photoreactive composition 520. Adjustment of the angle of each mirror 540 causes the beams 550 to be steered into selected non-overlapping volumes of the photoreactive composition (i.e., focal points 522a-522c).

This invention is not limited to optical systems incorporating the movable micro-mirrors described above, but includes all forms of electronically-configurable reflective, refractive, or diffractive optical elements, including, but not limited to, polymer-dispersed liquid-crystal lenses, deformable mirrors commonly used in adaptive optical systems, and tunable gratings. Synchronization of the signal controlling the action of the adjustable optical element and the motion of a precision translation stage holding the photoreactive composition greatly reduces the total exposure time of a complex three-dimensional structure within a photoreactive composition.

It is to be understood that the complete optical system is to be optimized to accommodate pulse widths in the range of femtoseconds to nanoseconds. Femtosecond light pulses have lengths on the order of micrometers, emphasizing the importance of the optical design (whether micro-optical, diffractive, or interferometric) in providing very small, complex, three-dimensional structures.

A system for multiphoton absorption can include an exposure system that includes a light source and an appropriate optical element, and a photoreactive composition that includes at least one reactive material, at least one multiphoton photosensitizer, optionally at least one electron donor compound, and optionally at least one photoinitiator for the photoreactive composition. The photoinitiator is typically optional except when the reactive species is a cationic resin.

An exposure system useful in the present invention includes a light source, usually a laser, and an appropriate optical element. Laser light sources useful in the invention can include, for example, a femtosecond near-infrared titanium sapphire oscillator (such as a Coherent 900-F) pumped by an argon ion laser (Coherent Innova 310) coupled into a laser scanning confocal microscope (BioRad MRC600) equipped with a 0.75 NA objective (Zeiss 20X Fluar). The laser, operating at 76 MHz, has a pulse width of 100 femtoseconds and is tunable between 700 and 1000 nm with a bandwidth of 10 nm (fwhm). In practice, any suitable light source that provides sufficient light energy at a wavelength appropriate for the photosensitizer used in the photoreactive system (see below) can be used.

Optical elements useful in the present invention can include, but are not limited to, refractive optical elements, reflective optical elements, diffractive optical elements, diffusers, wave guides, and the like. Refractive optical elements include lenses, mirrors, prisms, and the like. Diffractive optical elements include gratings, phase masks, holograms, and the like. Reflective optical elements include retroreflectors, focusing mirrors, and the like. Many other optical elements can be used as would be known to one of skill in the art. Examples include diffusers, Pockels cells, wave-guides, wave plates, birefringent liquid crystals, and the like.

Reactive Species

Reactive species suitable for use in the photoreactive compositions include both curable and non-curable species. Curable species are generally preferred and include, for example, addition-polymerizable monomers and oligomers and addition-crosslinkable polymers (such as free-radically polymerizable or crosslinkable ethylenically-unsaturated species including, for example, acrylates, methacrylates, and certain vinyl compounds such as styrenes), as well as cationically-polymerizable monomers and oligomers and cationically-crosslinkable polymers (including, for example, epoxies, vinyl ethers, cyanate esters, etc.), and the like, and mixtures thereof.

Suitable ethylenically-unsaturated species are described, for example, by Palazzotto et al. in U.S. Pat. No. 5,545,676 at column 1, line 65, through column 2, line 26, and include mono-, di-, and poly-acrylates and methacrylates (for example, methyl acrylate, methyl methacrylate, ethyl acrylate, isopropyl methacrylate, n-hexyl acrylate, stearyl acrylate, allyl acrylate, glycerol diacrylate, glycerol triacrylate, ethyleneglycol diacrylate, diethyleneglycol diacrylate, triethyleneglycol dimethacrylate,1,3-propanediol diacrylate, 1,3-propanediol dimethacrylate, trimethylolpropane triacrylate, 1,2,4-butanetriol trimethacrylate, 1,4-cyclohexanediol diacrylate, pentaerythritol triacrylate, pentaerythritol tetraacrylate, pentaerythritol tetramethacrylate, sorbitol hexacrylate, bis[1-(2-acryloxy)]-p-ethoxyphenyldimethylmethane, bis[1-(3-acryloxy-2-hydroxy)]-p-propoxyphenyldimethylmethane, trishydroxyethyl-isocyanurate trimethacrylate, the bis-acrylates and bis-methacrylates of polyethylene glycols of molecular weight about 200-500, copolymerizable mixtures of acrylated monomers such as those of U.S. Pat. No. 4,652,274, and acrylated oligomers such as those of U.S. Pat. No. 4,642,126); unsaturated amides (for example, methylene bis-acrylamide, methylene bis-methacrylamide, 1,6-hexamethylene bis-acrylamide, diethylene triamine tris-acrylamide and beta-methacrylaminoethyl methacrylate); vinyl compounds (for example, styrene, diallyl phthalate, divinyl succinate, divinyl adipate, and divinyl phthalate); and the like; and mixtures thereof. Suitable reactive polymers include polymers with pendant (meth)acrylate groups, for example, having from 1 to about 50 (meth)acrylate groups per polymer chain. Examples of such polymers include aromatic acid (meth)acrylate half ester resins such as Sarbox™ resins available from Sartomer (for example, Sarbox™ 400, 401, 402, 404, and 405). Other useful reactive polymers curable by free radical chemistry include those polymers that have a hydrocarbyl backbone and pendant peptide groups with free-radically polymerizable functionality attached thereto, such as those described in U.S. Pat. No. 5,235,015 (Ali et al.). Mixtures of two or more monomers, oligomers, and/or reactive polymers can be used if desired. Preferred ethylenically-unsaturated species include acrylates, aromatic acid (meth)acrylate half ester resins, and polymers that have a hydrocarbyl backbone and pendant peptide groups with free-radically polymerizable functionality attached thereto.

Suitable cationically-reactive species are described, for example, by Oxman et al. in U.S. Pat. Nos. 5,998,495 and 6,025,406 and include epoxy resins. Such materials, broadly called epoxides, include monomeric epoxy compounds and epoxides of the polymeric type and can be aliphatic, alicyclic, aromatic, or heterocyclic. These materials generally have, on the average, at least 1 polymerizable epoxy group per molecule (preferably, at least about 1.5 and, more preferably, at least about 2). The polymeric epoxides include linear polymers having terminal epoxy groups (for example, a diglycidyl ether of a polyoxyalkylene glycol), polymers having skeletal oxirane units (for example, polybutadiene polyepoxide), and polymers having pendant epoxy groups (for example, a glycidyl methacrylate polymer or copolymer). The epoxides can be pure compounds or can be mixtures of compounds containing one, two, or more epoxy groups per molecule. These epoxy-containing materials can vary greatly in the nature of their backbone and substituent groups. For example, the backbone can be of any type and substituent groups thereon can be any group that does not substantially interfere with cationic cure at room temperature. Illustrative of permissible substituent groups include halogens, ester groups, ethers, sulfonate groups, siloxane groups, nitro groups, phosphate groups, and the like. The molecular weight of the epoxy-containing materials can vary from about 58 to about 100,000 or more.

Useful epoxy-containing materials include those which contain cyclohexene oxide groups such as epoxycyclohexanecarboxylates, typified by 3,4-epoxycyclohexylmethyl-3,4-epoxycyclohexanecarboxylate, 3,4-epoxy-2-methylcyclohexylmethyl-3,4-epoxy-2-methylcyclohexane carboxylate, and bis(3,4-epoxy-6-methylcyclohexylmethyl) adipate. A more detailed list of useful epoxides of this nature is set forth in U.S. Pat. No. 3,117,099.

Other epoxy-containing materials that are useful include glycidyl ether monomers of the formula

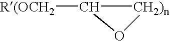

where R′ is alkyl or aryl and n is an integer of 1 to 6. Examples are glycidyl ethers of polyhydric phenols obtained by reacting a polyhydric phenol with an excess of a chlorohydrin such as epichlorohydrin (for example, the diglycidyl ether of 2,2-bis-(2,3-epoxypropoxyphenol)-propane). Additional examples of epoxides of this type are described in U.S. Pat. No. 3,018,262, and in Handbook of Epoxy Resins, Lee and Neville, McGraw-Hill Book Co., New York (1967).

Numerous commercially available epoxy resins can also be utilized. In particular, epoxides that are readily available include octadecylene oxide, epichlorohydrin, styrene oxide, vinyl cyclohexene oxide, glycidol, glycidylmethacrylate, diglycidyl ethers of Bisphenol A (for example, those available under the trade designations Epon™ 828, Epon™ 825, Epon™ 1004, and Epon™ 1010 from Resolution Performance Products, formerly Shell Chemical Co., as well as DER™-331, DER™-332, and DER™334 from Dow Chemical Co.), vinylcyclohexene dioxide (for example, ERL-4206 from Union Carbide Corp.), 3,4-epoxycyclohexylmethyl-3,4-epoxycyclohexene carboxylate (for example, ERL-4221 or Cyracure™ UVR 6110 or UVR 6105 from Union Carbide Corp.), 3,4-epoxy-6-methylcyclohexylmethyl-3,4-epoxy-6-methyl-cyclohexene carboxylate (for example, ERL-4201 from Union Carbide Corp.), bis(3,4-epoxy-6-methylcyclohexylmethyl) adipate (for example, ERL-4289 from Union Carbide Corp.), bis(2,3-epoxycyclopentyl) ether (for example, ERL-0400 from Union Carbide Corp.), aliphatic epoxy modified from polypropylene glycol (for example, ERL-4050 and ERL-4052 from Union Carbide Corp.), dipentene dioxide (for example, ERL-4269 from Union Carbide Corp.), epoxidized polybutadiene (for example, Oxironm 2001 from FMC Corp.), silicone resin containing epoxy functionality, flame retardant epoxy resins (for example, DER™-580, a brominated bisphenol type epoxy resin available from Dow Chemical Co.), 1,4-butanediol diglycidyl ether of phenolformaldehyde novolak (for example, DEN™-431 and DEN™-438 from Dow Chemical Co.), resorcinol diglycidyl ether (for example, Kopoxite™ from Koppers Company, Inc.), bis(3,4-epoxycyclohexyl)adipate (for example, ERL-4299 or UVR-6128, from Union Carbide Corp.), 2-(3,4-epoxycyclohexyl-5,5-spiro-3,4-epoxy) cyclohexane-meta-dioxane (for example, ERL-4234 from Union Carbide Corp.), vinylcyclohexene monoxide 1,2-epoxyhexadecane (for example, UVR-6216 from Union Carbide Corp.), alkyl glycidyl ethers such as alkyl C₈-C₁₀ glycidyl ether (for example, Heloxy™ Modifier 7 from Resolution Performance Products), alkyl C₁₂-C₁₄ glycidyl ether (for example, Heloxy™ Modifier 8 from Resolution Performance Products), butyl glycidyl ether (for example, Heloxy™ Modifier 61 from Resolution Performance Products), cresyl glycidyl ether (for example, Heloxy™ Modifier 62 from Resolution Performance Products), p-tert-butylphenyl glycidyl ether (for example, Heloxy™ Modifier 65 from Resolution Performance Products), polyfunctional glycidyl ethers such as diglycidyl ether of 1,4-butanediol (for example, Heloxy™ Modifier 67 from Resolution Performance Products), diglycidyl ether of neopentyl glycol (for example, Heloxy™ Modifier 68 from Resolution Performance Products), diglycidyl ether of cyclohexanedimethanol (for example, Heloxy™ Modifier 107 from Resolution Performance Products), trimethylol ethane triglycidyl ether (for example, Heloxy™ Modifier 44 from Resolution Performance Products), trimethylol propane triglycidyl ether (for example, Heloxy™ Modifier 48 from Resolution Performance Products), polyglycidyl ether of an aliphatic polyol (for example, Heloxy™ Modifier 84 from Resolution Performance Products), polyglycol diepoxide (for example, Heloxy™ Modifier 32 from Resolution Performance Products), bisphenol F epoxides (for example, Epon™-1138 or GY-281 from Ciba-Geigy Corp.), and 9,9-bis[4-(2,3-epoxypropoxy)-phenyl]fluorenone (for example, Epon™ 1079 from Resolution Performance Products).

Other useful epoxy resins comprise copolymers of acrylic acid esters of glycidol (such as glycidylacrylate and glycidylmethacrylate) with one or more copolymerizable vinyl compounds. Examples of such copolymers are 1:1 styrene-glycidylmethacrylate, 1:1 methylmethacrylate-glycidylacrylate, and a 62.5:24:13.5 methylmethacrylate-ethyl acrylate-glycidylmethacrylate. Other useful epoxy resins are well known and contain such epoxides as epichlorohydrins, alkylene oxides (for example, propylene oxide), styrene oxide, alkenyl oxides (for example, butadiene oxide), and glycidyl esters (for example, ethyl glycidate).

Useful epoxy-functional polymers include epoxy-functional silicones such as those described in U.S. Pat. No. 4,279,717 (Eckberg), which are commercially available from the General Electric Company. These are polydimethylsiloxanes in which 1-20 mole % of the silicon atoms have been substituted with epoxyalkyl groups (preferably, epoxy cyclohexylethyl, as described in U.S. Pat. No. 5,753,346 (Kessel)).

Blends of various epoxy-containing materials can also be utilized. Such blends can comprise two or more weight average molecular weight distributions of epoxy-containing compounds (such as low molecular weight (below 200), intermediate molecular weight (about 200 to 10,000), and higher molecular weight (above about 10,000)). Alternatively or additionally, the epoxy resin can contain a blend of epoxy-containing materials having different chemical natures (such as aliphatic and aromatic) or functionalities (such as polar and non-polar). Other cationically-reactive polymers (such as vinyl ethers and the like) can additionally be incorporated, if desired.

Preferred epoxies include aromatic glycidyl epoxies (such as the Epon™ resins available from Resolution Performance Products) and cycloaliphatic epoxies (such as ERL-4221 and ERL-4299 available from Union Carbide).

Suitable cationally-reactive species also include vinyl ether monomers, oligomers, and reactive polymers (for example, methyl vinyl ether, ethyl vinyl ether, tert-butyl vinyl ether, isobutyl vinyl ether, triethyleneglycol divinyl ether (Rapi-Cure™ DVE-3, available from International Specialty Products, Wayne, N.J.), trimethylolpropane trivinyl ether (TMPTVE, available from BASF Corp., Mount Olive, N.J.), and the Vectomer™ divinyl ether resins from Allied Signal (for example, Vectomer™ 2010, Vectomer™ 2020, Vectomer™ 4010, and Vectomer™ 4020 and their equivalents available from other manufacturers)), and mixtures thereof. Blends (in any proportion) of one or more vinyl ether resins and/or one or more epoxy resins can also be utilized. Polyhydroxy-functional materials (such as those described, for example, in U.S. Pat. No. 5,856,373 (Kalsaki et al.)) can also be utilized in combination with epoxy- and/or vinyl ether-functional materials.

Non-curable species include, for example, reactive polymers whose solubility can be increased upon acid- or radical-induced reaction. Such reactive polymers include, for example, aqueous insoluble polymers bearing ester groups that can be converted by photogenerated acid to aqueous soluble acid groups (for example, poly(4-tert-butoxycarbonyloxystyrene). Non-curable species also include the chemically-amplified photoresists described by R. D. Allen, G. M. Wallraff, W. D. Hinsberg, and L. L. Simpson in “High Performance Acrylic Polymers for Chemically Amplified Photoresist Applications,” J. Vac. Sci. Technol. 1, 9, 3357 (1991). The chemically-amplified photoresist concept is now widely used for microchip manufacturing, especially with sub-0.5 micron (or even sub-0.2 micron) features. In such photoresist systems, catalytic species (typically hydrogen ions) can be generated by irradiation, which induces a cascade of chemical reactions. This cascade occurs when hydrogen ions initiate reactions that generate more hydrogen ions or other acidic species, thereby amplifying reaction rate. Examples of typical acid-catalyzed chemically-amplified photoresist systems include deprotection (for example, t-butoxycarbonyloxystyrene resists as described in U.S. Pat. No. 4,491,628, tetrahydropyran (THP) methacrylate-based materials, THP-phenolic materials such as those described in U.S. Pat. No. 3,779,778, t-butyl methacrylate-based materials such as those described by R. D Allen et al. in Proc. SPIE, 2438, 474 (1995), and the like); depolymerization (for example, polyphthalaldehyde-based materials); and rearrangement (for example, materials based on the pinacol rearrangements).

Useful non-curable species also include leuco dyes, which tend to be colorless until they are oxidized by acid generated by the multiphoton photoinitiator system, and which, once oxidized, exhibit a visible color. (Oxidized dyes are colored by virtue of their absorbance of light in the visible portion of the electromagnetic spectrum (approximately 400-700 nm).) Leuco dyes useful in the present invention are those that are reactive or oxidizable under moderate oxidizing conditions and yet that are not so reactive as to oxidize under common environmental conditions. There are many such chemical classes of leuco dyes known to the imaging chemist.

Leuco dyes useful as reactive species in the present invention include acrylated leuco azine, phenoxazine, and phenothiazine, which can, in part, be represented by the structural formula:

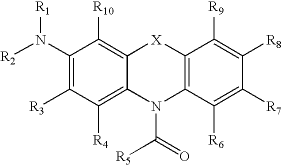

wherein X is selected from O, S, and —N—R¹¹, with S being preferred;

R¹ and R² are independently selected from H and alkyl groups of 1 to about 4 carbon atoms; R³, R⁴, R⁶, and R⁷ are independently selected from H and alkyl groups of 1 to about 4 carbon atoms, preferably methyl; R⁵ is selected from alkyl groups of 1 to about 16 carbon atoms, alkoxy groups of 1 to about 16 carbon atoms, and aryl groups of up to about 16 carbon atoms; R⁸ is selected from —N(R¹)(R²), H, alkyl groups of 1 to about 4 carbon atoms, wherein R¹ and R² are independently selected and defined as above; R⁹ and R¹⁰ are independently selected from H and alkyl groups of 1 to about 4 carbon atoms; and R¹¹ is selected from alkyl groups of 1 to about 4 carbon atoms and aryl groups of up to about 11 carbon atoms (preferably, phenyl groups). The following compounds are examples of this type of leuco dye:

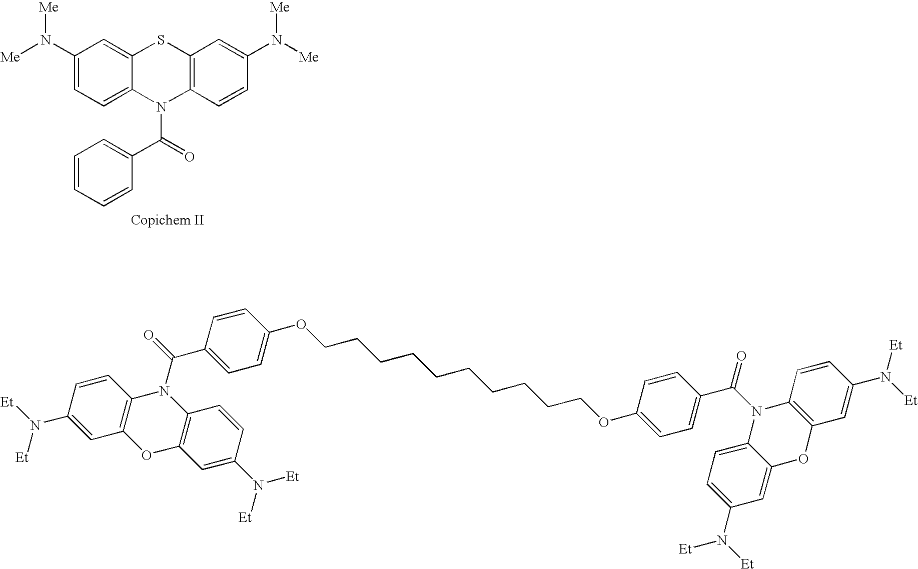

Other useful leuco dyes include, but are not limited to, Leuco Crystal Violet (4,4′,4″-methylidynetris-(N,N-dimethylaniline)), Leuco Malachite Green (p,p′-benzylidenebis-(N,N-dimethylaniline)), Leuco Atacryl Orange-LGM (Color Index Basic Orange 21, Comp. No. 48035 (a Fischer's base type compound)) having the structure

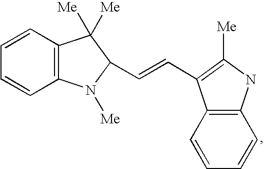

Leuco Atacryl Brilliant Red-4G (Color index Basic Red 14) having the structure

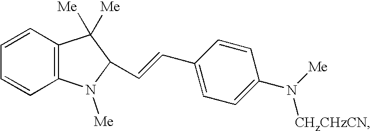

Leuco Atacryl Yellow-R (Color Index Basic Yellow 11, Comp. No. 48055) having the structure

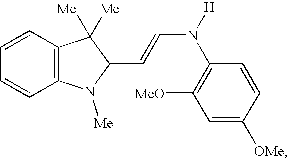

Leuco Ethyl Violet (4,4′,4″-methylidynetris-(N,N-diethylaniline), Leuco Victoria Blu-BGO (Color Index Basic Blue 728a, Comp. No. 44040; 4,4′-methylidynebis-(N,N,-dimethylaniline)-4-(N-ethyl-1-napthalamine)), and LeucoAtlantic Fuchsine Crude (4,4′,4″-methylidynetris-aniline).

The leuco dye(s) can generally be present at levels of at least about 0.01% by weight of the total weight of a light sensitive layer (preferably, at least about 0.3% by weight; more preferably, at least about 1% by weight; most preferably, at least about 2% to 10% or more by weight). Other materials such as binders, plasticizers, stabilizers, surfactants, antistatic agents, coating aids, lubricants, fillers, and the like can also be present in the light sensitive layer. One of skill in the art can readily determine the desirable amount of additives. For example, the amount of filler is chosen such that there is no undesirable scatter at the writing wavelength.

If desired, mixtures of different types of reactive species can be utilized in the photoreactive compositions. For example, mixtures of free-radically-reactive species and cationically-reactive species, mixtures of curable species and non-curable species, and so forth, are also useful.

Photoinitiator System

(1) Multiphoton Photosensitizers

Multiphoton photosensitizers suitable for use in the multiphoton photoinitiator system of the photoreactive compositions are those that are capable of simultaneously absorbing at least two photons when exposed to sufficient light. Preferably, they have a two-photon absorption cross-section greater than that of fluorescein (that is, greater than that of 3′,6′-dihydroxyspiro[isobenzofuran-1(3H), 9′-[9H]xanthen]3-one). Generally, the cross-section can be greater than about 50×10⁻⁵⁰ cm⁴ sec/photon, as measured by the method described by C. Xu and W. W. Webb in J. Opt. Soc. Am. B, 13, 481 (1996) (which is referenced by Marder and Perry et al. in International Publication No. WO 98/21521 at page 85, lines 18-22).

This method involves the comparison (under identical excitation intensity and photosensitizer concentration conditions) of the two-photon fluorescence intensity of the photosensitizer with that of a reference compound. The reference compound can be selected to match as closely as possible the spectral range covered by the photosensitizer absorption and fluorescence. In one possible experimental set-up, an excitation beam can be split into two arms, with 50% of the excitation intensity going to the photosensitizer and 50% to the reference compound. The relative fluorescence intensity of the photosensitizer with respect to the reference compound can then be measured using two photomultiplier tubes or other calibrated detector. Finally, the fluorescence quantum efficiency of both compounds can be measured under one-photon excitation.

Methods of determining fluorescence and phosphorescence quantum yields are well-known in the art. Typically, the area under the fluorescence (or phosphorescence) spectrum of a compound of interest is compared with the area under the fluorescence (or phosphorescence) spectrum of a standard luminescent compound having a known fluorescence (or phosphorescence) quantum yield, and appropriate corrections are made (which take into account, for example, the optical density of the composition at the excitation wavelength, the geometry of the fluorescence detection apparatus, the differences in the emission wavelengths, and the response of the detector to different wavelengths). Standard methods are described, for example, by I. B. Berlman in Handbook of Fluorescence Spectra of Aromatic Molecules, Second Edition, pages 24-27, Academic Press, New York (1971); by J. N. Demas and G. A. Crosby in J. Phys. Chem., 75, 991-1024 (1971); and by J. V. Morris, M. A. Mahoney, and J. R. Huber in J. Phys. Chem., 80, 969-974 (1976).

Assuming that the emitting state is the same under one- and two-photon excitation (a common assumption), the two-photon absorption cross-section of the photosensitizer, (δₛₐₘ) is equal to δ_{ref} K (Iₛₐₘ/I_{ref})(φₛₐₘ/φ_{ref}), wherein δ_{ref} is the two-photon absorption cross-section of the reference compound, Iₛₐₘ is the fluorescence intensity of the photosensitizer, I_{ref} is the fluorescence intensity of the reference compound, φₛₐₘ is the fluorescence quantum efficiency of the photosensitizer, φ_{ref} is the fluorescence quantum efficiency of the reference compound, and K is a correction factor to account for slight differences in the optical path and response of the two detectors. K can be determined by measuring the response with the same photosensitizer in both the sample and reference arms. To ensure a valid measurement, the clear quadratic dependence of the two-photon fluorescence intensity on excitation power can be confirmed, and relatively low concentrations of both the photosensitizer and the reference compound can be utilized (to avoid fluorescence reabsorption and photosensitizer aggregration effects).

When the photosensitizer is not fluorescent, the yield of electronic excited states can to be measured and compared with a known standard. In addition to the above-described method of determining fluorescence yield, various methods of measuring excited state yield are known (including, for example, transient absorbance, phosphorescence yield, photoproduct formation or disappearance of photosensitizer (from photoreaction), and the like).

Preferably, the two-photon absorption cross-section of the photosensitizer is greater than about 1.5 times that of fluorescein (or, alternatively, greater than about 75×10⁻⁵ cm⁴ sec/photon, as measured by the above method); more preferably, greater than about twice that of fluorescein (or, alternatively, greater than about 100×10⁻⁵⁰ cm⁴ sec/photon); most preferably, greater than about three times that of fluorescein (or, alternatively, greater than about 150×10⁻⁵⁰ cm⁴ sec/photon); and optimally, greater than about four times that of fluorescein (or, alternatively, greater than about 200×10⁻⁵⁰ cm⁴ sec/photon).

Preferably, the photosensitizer is soluble in the reactive species (if the reactive species is liquid) or is compatible with the reactive species and with any binders (as described below) that are included in the composition. Most preferably, the photosensitizer is also capable of sensitizing 2-methyl-4,6-bis(trichloromethyl)-s-triazine under continuous irradiation in a wavelength range that overlaps the single photon absorption spectrum of the photosensitizer (single photon absorption conditions), using the test procedure described in U.S. Pat. No. 3,729,313. Using currently available materials, that test can be carried out as follows:

A standard test solution can be prepared having the following composition:

5.0 parts of a 5% (weight by volume) solution in methanol of 45,000-55,000 molecular weight, 9.0-13.0% hydroxyl content polyvinyl butyral (Butvar™ B76, Monsanto);

0.3 parts trimethylolpropane trimethacrylate; and 0.03 parts 2-methyl-4,6-bis(trichloromethyl)-s-triazine (see Bull. Chem. Soc. Japan, 42, 2924-2930 (1969)). To this solution can be added 0.01 parts of the compound to be tested as a photosensitizer. The resulting solution can then be knife-coated onto a 0.05 mm clear polyester film using a knife orifice of 0.05 mm, and the coating can be air dried for about 30 minutes. A 0.05 mm clear polyester cover film can be carefully placed over the dried but soft and tacky coating with minimum entrapment of air. The resulting sandwich construction can then be exposed for three minutes to 161,000 Lux of incident light from a tungsten light source providing light in both the visible and ultraviolet range (FCH™ 650 watt quartz-iodine lamp, General Electric). Exposure can be made through a stencil so as to provide exposed and unexposed areas in the construction. After exposure the cover film can be removed, and the coating can be treated with a finely divided colored powder, such as a color toner powder of the type conventionally used in xerography. If the tested compound is a photosensitizer, the trimethylolpropane trimethacrylate monomer will be polymerized in the light-exposed areas by the light-generated free radicals from the 2-methyl-4,6-bis(trichloromethyl)-s-triazine. Since the polymerized areas will be essentially tack-free, the colored powder will selectively adhere essentially only to the tacky, unexposed areas of the coating, providing a visual image corresponding to that in the stencil.

Preferably, a photosensitizer can also be selected based in part upon shelf stability considerations. Accordingly, selection of a particular photosensitizer can depend to some extent upon the particular reactive species utilized (as well as upon the choices of electron donor compound and/or photoinitiator).

Particularly preferred multiphoton photosensitizers include those exhibiting large multiphoton absorption cross-sections, such as Rhodamine B (that is, N-[9-(2-carboxyphenyl)-6-(diethylamino)-3H-xanthen-3-ylidene]-N-ethylethanaminium chloride, and the hexafluoroantimonate salt of Rhodamine B) and the four classes of photosensitizers described, for example, by Marder and Perry et al. in International Patent Publication Nos. WO 98/21521 and WO 99/53242. The four classes can be described as follows: (a) molecules in which two donors are connected to a conjugated π (pi)-electron bridge; (b) molecules in which two donors are connected to a conjugated π (pi)-electron bridge which is substituted with one or more electron accepting groups; (c) molecules in which two acceptors are connected to a conjugated π (pi)-electron bridge; and (d) molecules in which two acceptors are connected to a conjugated π (pi)-electron bridge which is substituted with one or more electron donating groups (where “bridge” means a molecular fragment that connects two or more chemical groups, “donor” means an atom or group of atoms with a low ionization potential that can be bonded to a conjugated π (pi)-electron bridge, and “acceptor” means an atom or group of atoms with a high electron affinity that can be bonded to a conjugated π (pi)-electron bridge).

Representative examples of such photosensitizers include:

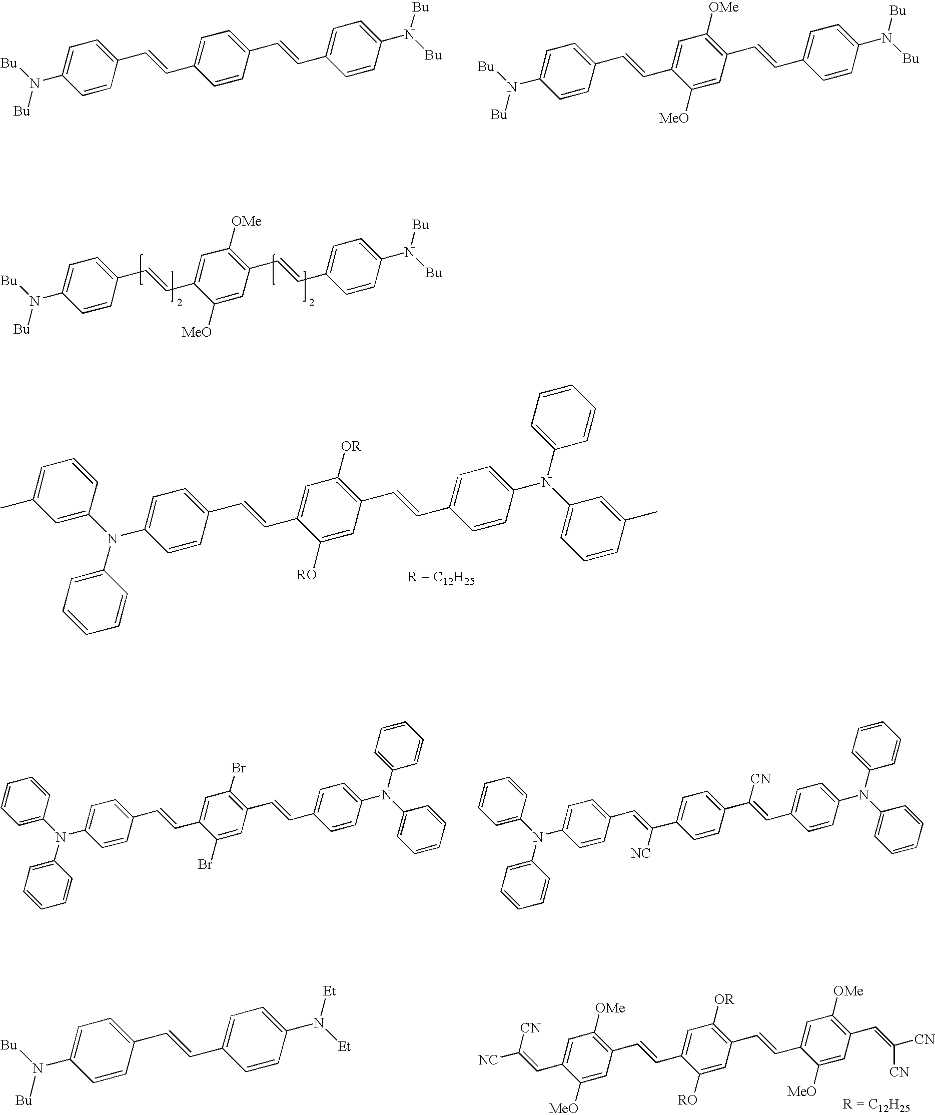

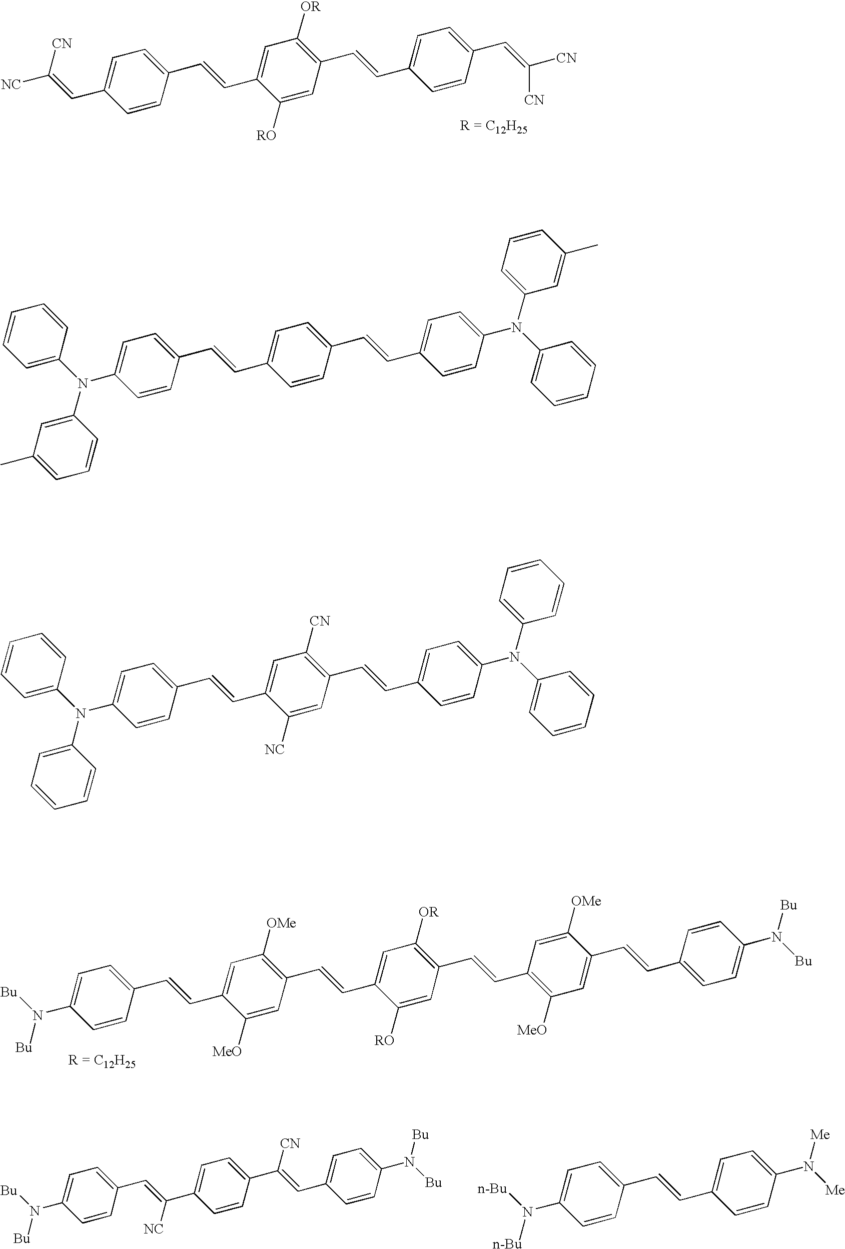

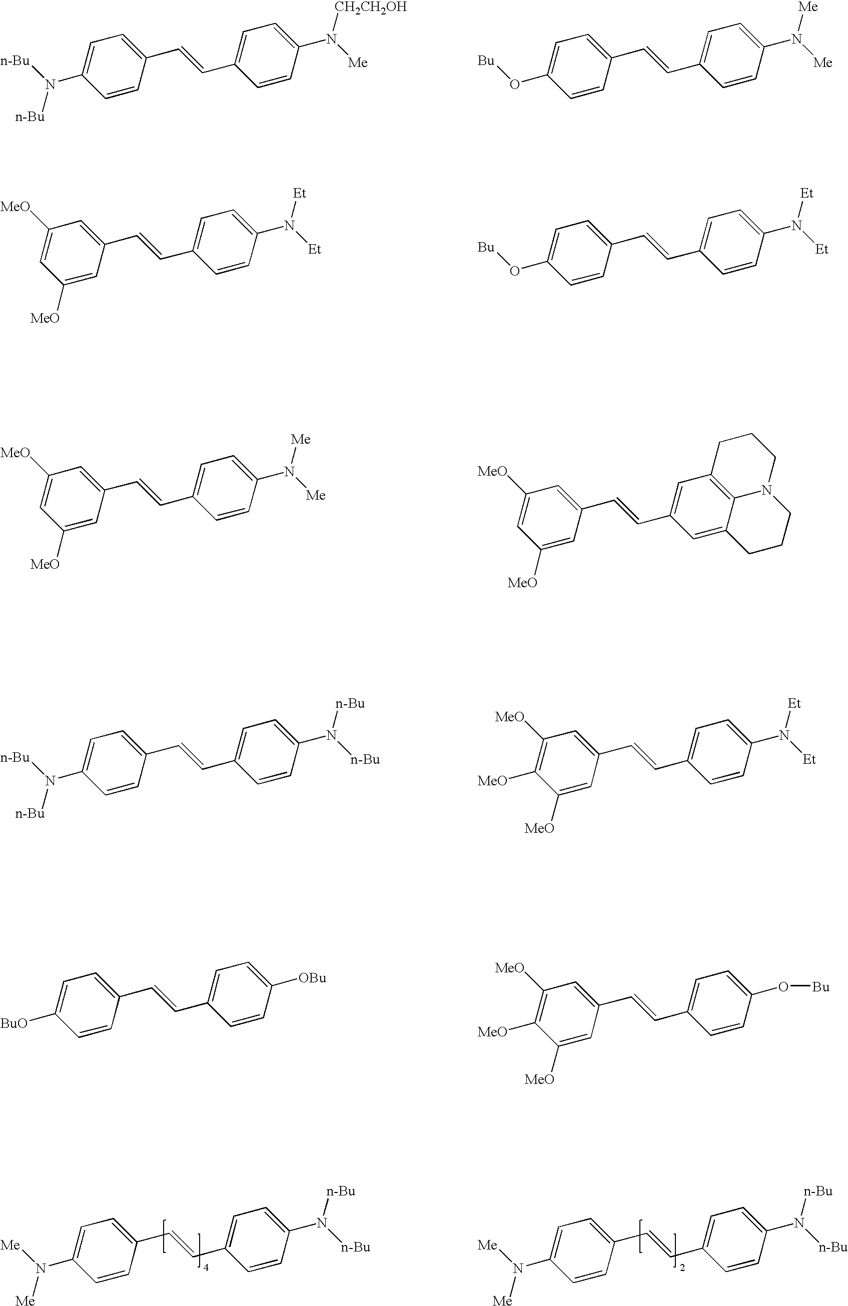

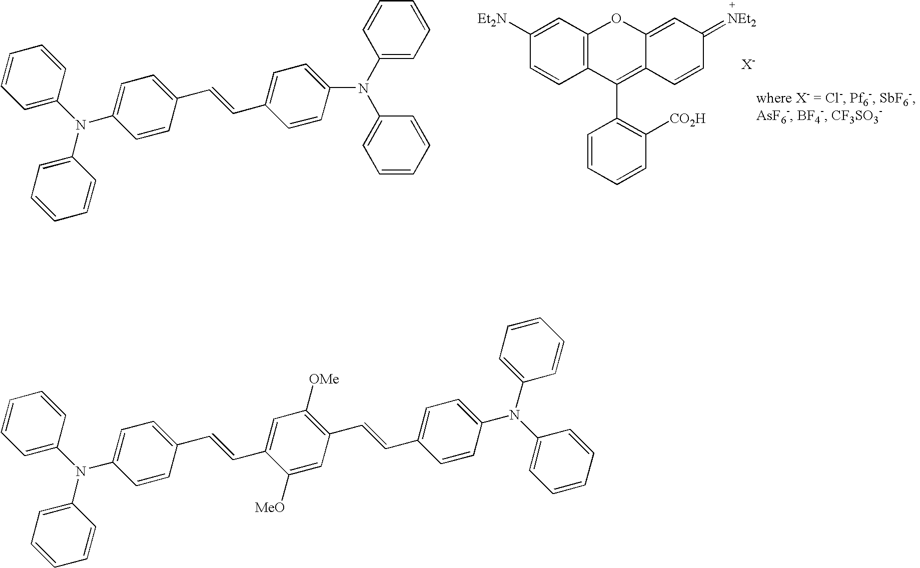

The four above-described classes of photosensitizers can be prepared by reacting aldehydes with ylides under standard Wittig conditions or by using the McMurray reaction, as detailed in International Patent Publication No. WO 98/21521.

Other compounds are described by Reinhardt et al. (for example, in U.S. Pat. Nos. 6,100,405, 5,859,251, and 5,770,737) as having large multiphoton absorption cross-sections, although these cross-sections were determined by a method other than that described above. Representative examples of such compounds include:

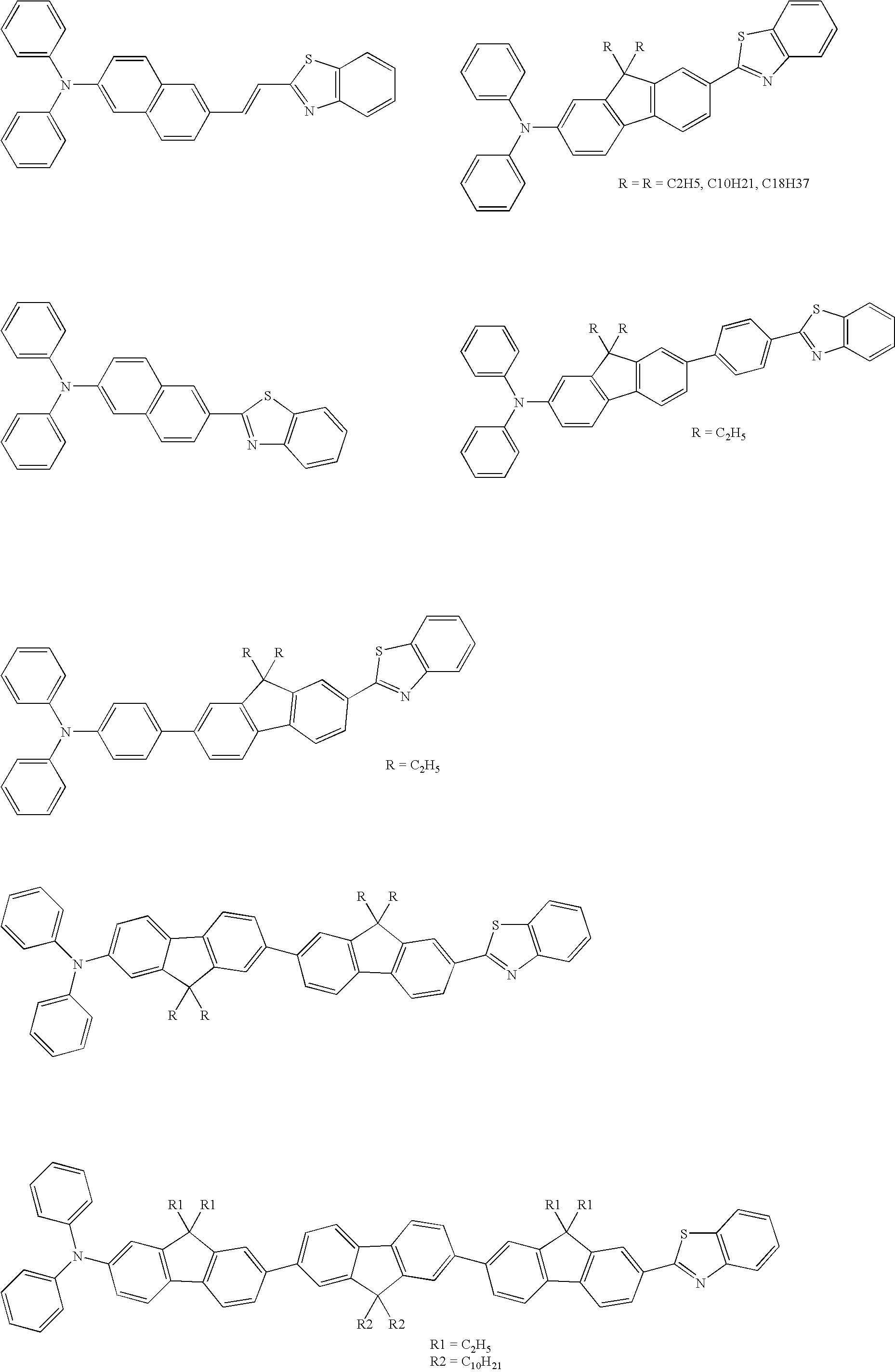

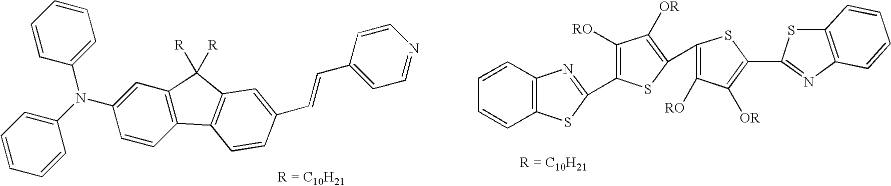

Other compounds which may be useful as photosensitizers in the present invention include but are not limited to fluorescein, p-bis(o-methylstyryl)benzene, eosin, rose Bengal, erythrosin, Coumarin 307 (Eastman Kodak), Cascade Blue hydrazide trisodium salt, Lucifer Yellow CH ammonium salt, 4,4-difluoro-1,3,5,7,8-pentamethyl-4-bora-3α,4α-diazaindacene-2,6-disulfonic acid disodium salt, 1,1-dioctadecyl-3,3,3′,3′-tetramethylindocarbocyanine perchlorate, Indo-1 pentapotassium salt (Molecular Probes), 5-dimethylaminonaphthalene-1-sulfonyl hydrazine, 4′,6-diamidino-2-phenylindole dihydrochloride, 5,7-diiodo-3-butoxy-6-fluorone, 9-fluorenone-2-carboxylic acid, and compounds having the following structures:

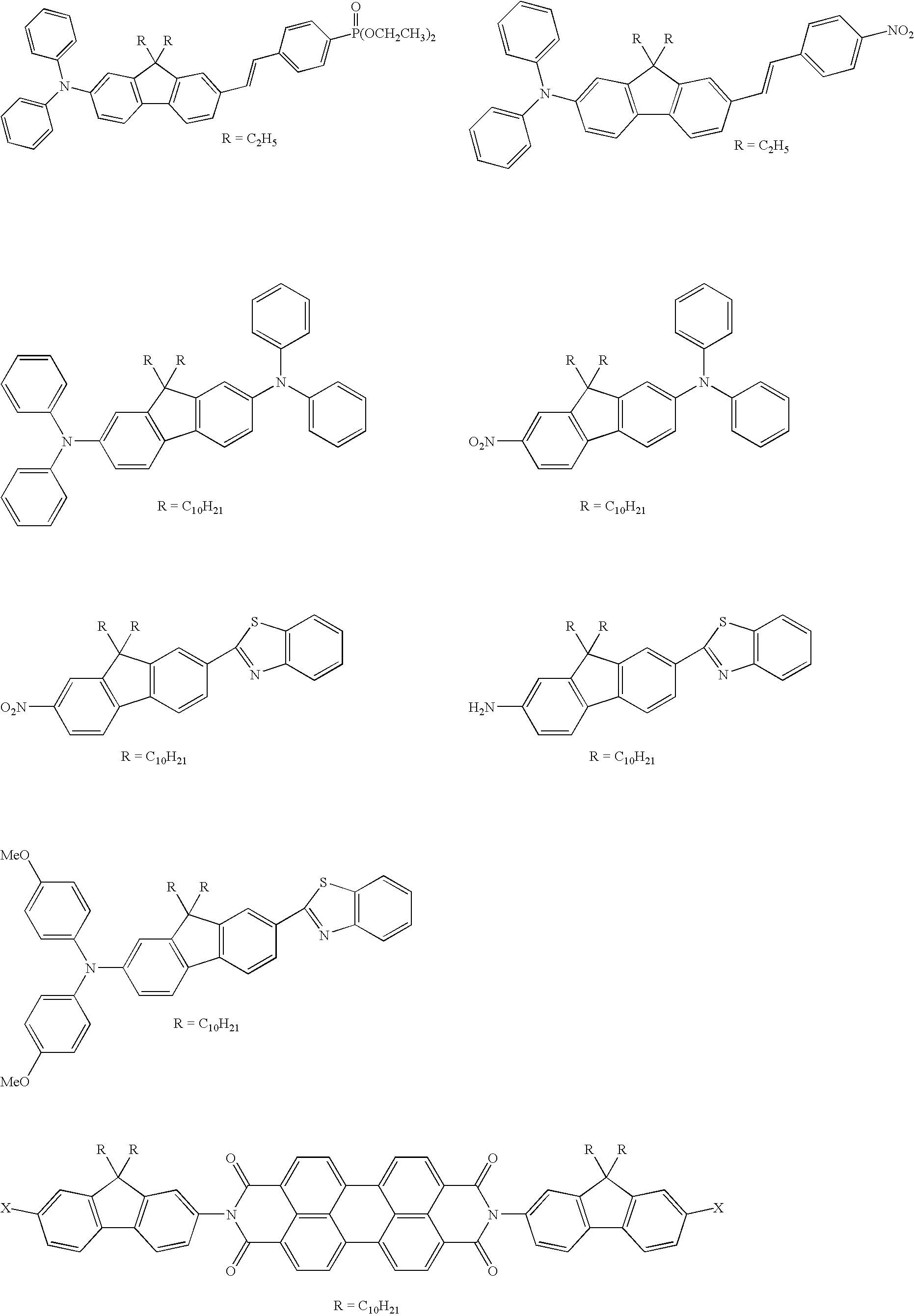

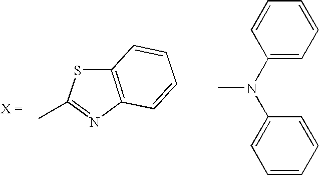

(2) Electron Donor Compounds

Electron donor compounds useful in the multiphoton photoinitiator system of the photoreactive compositions are those compounds (other than the photosensitizer itself) that are capable of donating an electron to an electronic excited state of the photosensitizer. The electron donor compounds preferably have an oxidation potential that is greater than zero and less than or equal to that of p-dimethoxybenzene vs. a standard saturated calomel electrode. Preferably, the oxidation potential is between about 0.3 and 1 volt vs. a standard saturated calomel electrode (S.C.E.).

The electron donor compound is also preferably soluble in the reactive species and is selected based in part upon shelf stability considerations (as described above). Suitable donors are generally capable of increasing the speed of reaction (e.g., cure) or the image density of a photoreactive composition upon exposure to light of the desired wavelength.

When working with cationically-reactive species, those skilled in the art will recognize that the electron donor compound, if of significant basicity, can adversely affect the cationic reaction. (See, for example, the discussion in U.S. Pat. No. 6,025,406 (Oxman et al.) at column 7, line 62, through column 8, line 49.)

In general, electron donor compounds suitable for use with particular photosensitizers and photoinitiators can be selected by comparing the oxidation and reduction potentials of the three components (as described, for example, in U.S. Pat. No. 4,859,572 (Farid et al.)). Such potentials can be measured experimentally (for example, by the methods described by R. J. Cox, Photographic Sensitivity, Chapter 15, Academic Press (1973)) or can be obtained from references such as N. L. Weinburg, Ed., Technique of Electroorganic Synthesis Part II Techniques of Chemistry, Vol. V (1975), and C. K. Mann and K. K. Barnes, Electrochemical Reactions in Nonaqueous Systems (1970). The potentials reflect relative energy relationships and can be used in the following manner to guide electron donor compound selection.

When the photosensitizer is in an electronic excited state, an electron in the highest occupied molecular orbital (HOMO) of the photosensitizer has been lifted to a higher energy level (namely, the lowest unoccupied molecular orbital (LUMO) of the photosensitizer), and a vacancy is left behind in the molecular orbital it initially occupied. The photoinitiator can accept the electron from the higher energy orbital, and the electron donor compound can donate an electron to fill the vacancy in the originally occupied orbital, provided that certain relative energy relationships are satisfied.

If the reduction potential of the photoinitiator is less negative (or more positive) than that of the photosensitizer, an electron in the higher energy orbital of the photosensitizer is readily transferred from the photosensitizer to the lowest unoccupied molecular orbital (LUMO) of the photoinitiator, since this represents an exothermic process. Even if the process is instead slightly endothermic (that is, even if the reduction potential of the photosensitizer is up to 0.1 volt more negative than that of the photoinitiator) ambient thermal activation can readily overcome such a small barrier.

In an analogous manner, if the oxidation potential of the electron donor compound is less positive (or more negative) than that of the photosensitizer, an electron moving from the HOMO of the electron donor compound to the orbital vacancy in the photosensitizer is moving from a higher to a lower potential, which again represents an exothermic process. Even if the process is slightly endothermic (that is, even if the oxidation potential of the photosensitizer is up to 0.1 volt more positive than that of the electron donor compound), ambient thermal activation can readily overcome such a small barrier.

Slightly endothermic reactions in which the reduction potential of the photosensitizer is up to 0.1 volt more negative than that of the photoinitiator, or the oxidation potential of the photosensitizer is up to 0.1 volt more positive than that of the electron donor compound, occur in every instance, regardless of whether the photoinitiator or the electron donor compound first reacts with the photosensitizer in its excited state. When the photoinitiator or the electron donor compound is reacting with the photosensitizer in its excited state, it is preferred that the reaction be exothermic or only slightly endothermic. When the photoinitiator or the electron donor compound is reacting with the photosensitizer ion radical, exothermic reactions are still preferred, but still more endothermic reactions can be expected in many instances to occur. Thus, the reduction potential of the photosensitizer can be up to 0.2 volt (or more) more negative than that of a second-to-react photoinitiator, or the oxidation potential of the photosensitizer can be up to 0.2 volt (or more) more positive than that of a second-to-react electron donor compound.

Suitable electron donor compounds include, for example, those described by D. F. Eaton in Advances in Photochemistry, edited by B. Voman et al., Volume 13, pp. 427-488, John Wiley and Sons, New York (1986); by Oxman et al. in U.S. Pat. No. 6,025,406 at column 7, lines 42-61; and by Palazzotto et al. in U.S. Pat. No. 5,545,676 at column 4, line 14 through column 5, line 18. Such electron donor compounds include amines (including triethanolamine, hydrazine, 1,4-diazabicyclo[2.2.2]octane, triphenylamine (and its triphenylphosphine and triphenylarsine analogs), aminoaldehydes, and aminosilanes), amides (including phosphoramides), ethers (including thioethers), ureas (including thioureas), sulfinic acids and their salts, salts of ferrocyanide, ascorbic acid and its salts, dithiocarbamic acid and its salts, salts of xanthates, salts of ethylene diamine tetraacetic acid, salts of (alkyl)ₙ(aryl)ₘborates (n+m=4) (tetraalkylammonium salts preferred), various organometallic compounds such as SnR₄ compounds (where each R is independently chosen from among alkyl, aralkyl (particularly, benzyl), aryl, and alkaryl groups) (for example, such compounds as n-C₃H₇Sn(CH₃)₃, (allyl)Sn(CH₃)₃, and (benzyl)Sn(n-C₃H₇)₃), ferrocene, and the like, and mixtures thereof. The electron donor compound can be unsubstituted or can be substituted with one or more non-interfering substituents. Particularly preferred electron donor compounds contain an electron donor atom (such as a nitrogen, oxygen, phosphorus, or sulfur atom) and an abstractable hydrogen atom bonded to a carbon or silicon atom alpha to the electron donor atom.

Preferred amine electron donor compounds include alkyl-, aryl-, alkaryl- and aralkyl-amines (for example, methylamine, ethylamine, propylamine, butylamine, triethanolamine, amylamine, hexylamine, 2,4-dimethylaniline, 2,3-dimethylaniline, o-, m- and p-toluidine, benzylamine, aminopyridine, N,N′-dimethylethylenediamine, N,N′-diethylethylenediamine, N,N′-dibenzylethylenediamine, N,N′-diethyl-1,3-propanediamine, N,N′-diethyl-2-butene-1,4-diamine, N,N′-dimethyl-1,6-hexanediamine, piperazine, 4,4′-trimethylenedipiperidine, 4,4′-ethylenedipiperidine, p-N,N-dimethyl-aminophenethanol and p-N-dimethylaminobenzonitrile); aminoaldehydes (for example, p-N,N-dimethylaminobenzaldehyde, p-N,N-diethylaminobenzaldehyde, 9-julolidine carboxaldehyde, and 4-morpholinobenzaldehyde); and aminosilanes (for example, trimethylsilylmorpholine, trimethylsilylpiperidine, bis(dimethylamino)diphenylsilane, tris(dimethylamino)methylsilane, N,N-diethylaminotrimethylsilane, tris(dimethylamino)phenylsilane, tris(methylsilyl)amine, tris(dimethylsilyl)amine, bis(dimethylsilyl)amine, N,N-bis(dimethylsilyl)aniline, N-phenyl-N-dimethylsilylaniline, and N,N-dimethyl-N-dimethylsilylamine); and mixtures thereof. Tertiary aromatic alkylamines, particularly those having at least one electron-withdrawing group on the aromatic ring, have been found to provide especially good shelf stability. Good shelf stability has also been obtained using amines that are solids at room temperature. Good photographic speed has been obtained using amines that contain one or more julolidinyl moieties.

Preferred amide electron donor compounds include N,N-dimethylacetamide, N,N-diethylacetamide, N-methyl-N-phenylacetamide, hexamethylphosphoramide, hexaethylphosphoramide, hexapropylphosphoramide, trimorpholinophosphine oxide, tripiperidinophosphine oxide, and mixtures thereof.

Preferred alkylarylborate salts include

Ar₃B⁻(n-C₄H₉)N⁺(C₂H₅)₄

Ar₃B⁻(n-C₄H₉)N⁺(CH₃)₄

Ar₃B⁻(n-C₄H₉)N⁺(n-C₄H₉)₄

Ar₃B⁻(n-C₄H₉)Li⁺

Ar₃B⁻(n-C₄H₉)N⁺(C₆H₁₃)₄

Ar₃B⁻(C₄H₉)N(CH₃)₃(CH₂)₂CO₂(CH₂)₂CH₃

Ar₃B⁻(C₄H₉)N⁺(CH₃)₃(CH₂)₂OCO(CH₂)₂CH₃

Ar₃B⁻(sec-C₄H₉)N⁺(CH₃)₃(CH₂)₂CO₂(CH₂)₂CH₃

Ar₃B⁻(sec-C₄H₉)N⁺(C₆H₁₃)₄

Ar₃B⁻(C₄H₉)N⁺(C₈H₁₇)₄

Ar₃B⁻(C₄H₉)N⁺(CH₃)₄

(p-CH₃O—C₆H₄)₃B⁻(n-C₄H₉)N(n-C₄H₉)₄

Ar₃B⁻(C₄H₉)N⁺(CH₃)₃(CH₂)₂OH

ArB⁻(n-C₄H₉)₃N⁺(CH₃)₄

ArB⁻(C₂H₅)₃N⁺(CH₃)₄

Ar₂B⁻(n-C₄H₉)₂N⁺(CH₃)₄

Ar₃B⁻(C₄H₉)N⁺(C₄H₉)₄

Ar₄B⁻N⁺(C₄H₉)₄

ArB⁻(CH₃)₃N⁺(CH₃)₄

(n-C₄H₉)₄B⁻N⁺(CH₃)₄

Ar₃B⁻(C₄H₉)P⁺(C₄H₉)₄

(where Ar is phenyl, naphthyl, substituted (preferably, fluoro-substituted) phenyl, substituted naphthyl, and like groups having greater numbers of fused aromatic rings), as well as tetramethylammonium n-butyltriphenylborate and tetrabutylammonium n-hexyl-tris(3-fluorophenyl)borate (available as CGI 437 and CGI 746 from Ciba Specialty Chemicals Corporation), and mixtures thereof.

Suitable ether electron donor compounds include 4,4′-dimethoxybiphenyl, 1,2,4-trimethoxybenzene, 1,2,4,5-tetramethoxybenzene, and the like, and mixtures thereof. Suitable urea electron donor compounds include N,N′-dimethylurea, N,N-dimethylurea, N,N′-diphenylurea, tetramethylthiourea, tetraethylthiourea, tetra-n-butylthiourea, N,N-di-n-butylthiourea, N,N′-di-n-butylthiourea, N,N-diphenylthiourea, N,N′-diphenyl-N,N′-diethylthiourea, and the like, and mixtures thereof.

Preferred electron donor compounds for free radical-induced reactions include amines that contain one or more julolidinyl moieties, alkylarylborate salts, and salts of aromatic sulfinic acids. However, for such reactions, the electron donor compound can also be omitted, if desired (for example, to improve the shelf stability of the photoreactive composition or to modify resolution, contrast, and reciprocity). Preferred electron donor compounds for acid-induced reactions include 4-dimethylaminobenzoic acid, ethyl 4-dimethylaminobenzoate, 3-dimethylaminobenzoic acid, 4-dimethylaminobenzoin, 4-dimethylaminobenzaldehyde, 4-dimethylaminobenzonitrile, 4-dimethylaminophenethyl alcohol, and 1,2,4-trimethoxybenzene.

(3) Photoinitiators

Suitable photoinitiators for the reactive species of the photoreactive compositions are those that are capable of being photosensitized by accepting an electron from an electronic excited state of the multiphoton photosensitizer, resulting in the formation of at least one free radical and/or acid. Such photoinitiators include iodonium salts (for example, diaryliodonium salts), chloromethylated triazines (for example, 2-methyl-4,6-bis(trichloromethyl)-s-triazine, 2,4,6-tris(trichloromethyl)-s-triazine, and 2-aryl-4,6-bis(trichloromethyl)-s-triazine), diazonium salts (for example, phenyldiazonium salts optionally substituted with groups such as alkyl, alkoxy, halo, or nitro), sulfonium salts (for example, triarylsulfonium salts optionally substituted with alkyl or alkoxy groups, and optionally having 2,2′ oxy groups bridging adjacent aryl moieties), azinium salts (for example, an N-alkoxypyridinium salt), and triarylimidazolyl dimers (preferably, 2,4,5-triphenylimidazolyl dimers such as 2,2′,4,4′,5,5′-tetraphenyl-1,1′-biimidazole, optionally substituted with groups such as alkyl, alkoxy, or halo), and the like, and mixtures thereof.

The photoinitiator is preferably soluble in the reactive species and is preferably shelf-stable (that is, does not spontaneously promote reaction of the reactive species when dissolved therein in the presence of the photosensitizer and the electron donor compound). Accordingly, selection of a particular photoinitiator can depend to some extent upon the particular reactive species, photosensitizer, and electron donor compound chosen, as described above. Preferred photoinitiators are those that exhibit large multiphoton adsorption cross-sections, as described, e.g., by Marder, Perry et al., in PCT Patent Applications WO 98/21521 and WO 995/3242, and by Goodman et al., in PCT Patent Application WO 99/54784.

Suitable iodonium salts include those described by Palazzotto et al. in U.S. Pat. No. 5,545,676 at column 2, lines 28 through 46. Suitable iodonium salts are also described in U.S. Pat. Nos. 3,729,313, 3,741,769, 3,808,006, 4,250,053 and 4,394,403. The iodonium salt can be a simple salt (for example, containing an anion such as Cl⁻, Br⁻, I⁻ or C₄H₅ SO₃⁻) or a metal complex salt (for example, containing SbF₆⁻, PF₆⁻, BF₄⁻, tetrakis(perfluorophenyl)borate, SbF₅ OH⁻ or AsF₆⁻). Mixtures of iodonium salts can be used if desired.

Examples of useful aromatic iodonium complex salt photoinitiators include diphenyliodonium tetrafluoroborate; di(4-methylphenyl)iodonium tetrafluoroborate; phenyl-4-methylphenyliodonium tetrafluoroborate; di(4-heptylphenyl)iodonium tetrafluoroborate; di(3-nitrophenyl)iodonium hexafluorophosphate; di(4-chlorophenyl)iodonium hexafluorophosphate; di(naphthyl)iodonium tetrafluoroborate; di(4-trifluoromethylphenyl)iodonium tetrafluoroborate; diphenyliodonium hexafluorophosphate; di(4-methylphenyl)iodonium hexafluorophosphate; diphenyliodonium hexafluoroarsenate; di(4-phenoxyphenyl)iodonium tetrafluoroborate; phenyl-2-thienyliodonium hexafluorophosphate; 3,5-dimethylpyrazolyl-4-phenyliodonium hexafluorophosphate; diphenyliodonium hexafluoroantimonate; 2,2′-diphenyliodonium tetrafluoroborate; di(2,4-dichlorophenyl)iodonium hexafluorophosphate; di(4-bromophenyl)iodonium hexafluorophosphate; di(4-methoxyphenyl)iodonium hexafluorophosphate; di(3-carboxyphenyl)iodonium hexafluorophosphate; di(3-methoxycarbonylphenyl)iodonium hexafluorophosphate; di(3-methoxysulfonylphenyl)iodonium hexafluorophosphate; di(4-acetamidophenyl)iodonium hexafluorophosphate; di(2-benzothienyl)iodonium hexafluorophosphate; and diphenyliodonium hexafluoroantimonate; and the like; and mixtures thereof. Aromatic iodonium complex salts can be prepared by metathesis of corresponding aromatic iodonium simple salts (such as, for example, diphenyliodonium bisulfate) in accordance with the teachings of Beringer et al., J. Am. Chem. Soc., 81, 342 (1959).

Preferred iodonium salts include diphenyliodonium salts (such as diphenyliodonium chloride, diphenyliodonium hexafluorophosphate, and diphenyliodonium tetrafluoroborate), diaryliodonium hexafluoroantimonate (for example, SarCat™ SR 1012 available from Sartomer Company), and mixtures thereof.

Useful chloromethylated triazines include those described in U.S. Pat. No. 3,779,778 (Smith et al.) at column 8, lines 45-50, which include 2,4-bis(trichloromethyl)-6-methyl-s-triazine, 2,4,6-tris(trichloromethyl)-s-triazine, and the more preferred chromophore-substituted vinylhalomethyl-s-triazines disclosed in U.S. Pat. Nos. 3,987,037 and 3,954,475 (Bonham et al.).

Useful diazonium salts include those described in U.S. Pat. No. 4,394,433 (Gatzke), which comprise a light sensitive aromatic moiety (for example, pyrrolidine, morpholine, aniline, and diphenyl amine) with an external diazonium group (—N⁺=N) and an anion (for example, chloride, tri-isopropyl naphthalene sulfonate, tetrafluoroborate, and the bis(perfluoroalkylsulfonyl)methides) associated therewith. Examples of useful diazonium cations include 1-diazo-4-anilinobenzene, N-(4-diazo-2,4-dimethoxy phenyl)pyrrolidine, 1-diazo-2,4-diethoxy-4-morpholino benzene, 1-diazo-4-benzoyl amino-2,5-diethoxy benzene, 4-diazo-2,5-dibutoxy phenyl morpholino, 4-diazo-1-dimethyl aniline, 1-diazo-N,N-dimethylaniline, 1-diazo-4-N-methyl-N-hydroxyethyl aniline, and the like.

Useful sulfonium salts include those described in U.S. Pat. No. 4,250,053 (Smith) at column 1, line 66, through column 4, line 2, which can be represented by the formulas:

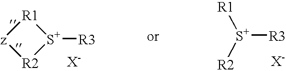

wherein R₁, R₂, and R₃ are each independently selected from aromatic groups having from about 4 to about 20 carbon atoms (for example, substituted or unsubstituted phenyl, naphthyl, thienyl, and furanyl, where substitution can be with such groups as alkoxy, alkylthio, arylthio, halogen, and so forth) and alkyl groups having from 1 to about 20 carbon atoms. As used here, the term “alkyl” includes substituted alkyl (for example, substituted with such groups as halogen, hydroxy, alkoxy, or aryl). At least one of R₁, R₂, and R₃ is aromatic, and, preferably, each is independently aromatic. Z is selected from the group consisting of a covalent bond, oxygen, sulfur, —S(═O)—, —C(═O)—, —(O═)S(═O)—, and —N(R)—, where R is aryl (of about 6 to about 20 carbons, such as phenyl), acyl (of about 2 to about 20 carbons, such as acetyl, benzoyl, and so forth), a carbon-to-carbon bond, or —(R₄—)C(—R₅)—, where R₄ and R₅ are independently selected from the group consisting of hydrogen, alkyl groups having from 1 to about 4 carbon atoms, and alkenyl groups having from about 2 to about 4 carbon atoms, and X⁻ is as described below.

Suitable anions, X⁻, for the sulfonium salts (and for any of the other types of photoinitiators) include a variety of anion types such as, for example, imide, methide, boron-centered, phosphorous-centered, antimony-centered, arsenic-centered, and aluminum-centered anions.

Illustrative, but not limiting, examples of suitable imide and methide anions include (C₂F₅SO₂)₂N⁻, (C₄F₉SO₂)₂N⁻, (C₈ F₁₇SO₂)₃C⁻, (CF₃SO₂)₃C⁻, (CF₃SO₂)₂N⁻, (C₄F₉SO₂)₃C⁻, (CF₃SO₂)₂(C₄F₉SO₂)C⁻, (CF₃SO₂)(C₄F₉SO₂)N⁻, ((CF₃)₂NC₂F₄SO₂)₂N⁻, (CF₃)₂NC₂F₄SO₂C⁻(SO₂ CF₃)₂, (3,5-bis(CF₃)C₆H₃)SO₂N⁻SO₂CF₃, C₆H₅SO₂C—(SO₂CF₃)₂, C₆H₅SO₂N—SO₂CF₃, and the like. Preferred anions of this type include those represented by the formula (R_{f}SO₂)₃C—, wherein R_{f} is a perfluoroalkyl radical having from 1 to about 4 carbon atoms.

Illustrative, but not limiting, examples of suitable boron-centered anions include F₄B⁻, (3,5-bis(CF₃)C₆H₃)₄B⁻, (C₆F₅)₄B⁻, (p-CF₃C₆H₄)₄B⁻, (m-CF₃C₆H₄)₄B⁻, (p-FC₆H₄)₄B⁻, (C₆F₅)₃(CH₃)B⁻, (C₆F₅)₃(n-C₄H₉)B⁻, (p-CH₃C₆H₄)₃(C₆F₅)B⁻, (C₆F₅)₃FB⁻, (C₆H₅)₃(C₆F₅)B⁻, (CH₃)₂(p-CF₃C₆H₄)₂B⁻, (C₆F₅)₃(n-C₁₈H₃₇0)B⁻, and the like. Preferred boron-centered anions generally contain 3 or more halogen-substituted aromatic hydrocarbon radicals attached to boron, with fluorine being the most preferred halogen. Illustrative, but not limiting, examples of the preferred anions include (3,5-bis(CF₃)C₆H₃)₄B⁻, (C₆F₅)₄B⁻, (C₆F₅)₃(n-C₄H₉)B⁻, (C₆F₅)₃FB⁻, and (C₆F₅)₃(CH₃)B⁻.

Suitable anions containing other metal or metalloid centers include, for example, (3,5-bis(CF₃)C₆H₃)₄Al⁻, (C₆F₅)₂F₄P⁻, (C₆F₅)F₅P⁻, F₆P⁻, (C₆F₅)F₅Sb⁻, F₆Sb⁻, (HO)F₅Sb⁻, and F₆As⁻. The foregoing lists are not intended to be exhaustive, as other useful boron-centered nonnucleophilic salts, as well as other useful anions containing other metals or metalloids, will be readily apparent (from the foregoing general formulas) to those skilled in the art.

Preferably, the anion, X⁻, is selected from tetrafluoroborate, hexafluorophosphate, hexafluoroarsenate, hexafluoroantimonate, and hydroxypentafluoroantimonate (for example, for use with cationically-reactive species such as epoxy resins).

Examples of suitable sulfonium salt photoinitiators include:

triphenylsulfonium tetrafluoroborate

methyldiphenylsulfonium tetrafluoroborate

dimethylphenylsulfonium hexafluorophosphate

triphenylsulfonium hexafluorophosphate

triphenylsulfonium hexafluoroantimonate

diphenylnaphthylsulfonium hexafluoroarsenate

tritolysulfonium hexafluorophosphate

anisyldiphenylsulfonium hexafluoroantimonate

4-butoxyphenyldiphenylsulfonium tetrafluoroborate

4-chlorophenyldiphenylsulfonium hexafluorophosphate

tri(4-phenoxyphenyl)sulfonium hexafluorophosphate

di(4-ethoxyphenyl)methylsulfonium hexafluoroarsenate

4-acetonylphenyldiphenylsulfonium tetrafluoroborate

4-thiomethoxyphenyldiphenylsulfonium hexafluorophosphate

di(methoxysulfonylphenyl)methylsulfonium hexafluoroantimonate

di(nitrophenyl)phenylsulfonium hexafluoroantimonate

di(carbomethoxyphenyl)methylsulfonium hexafluorophosphate

4-acetamidophenyldiphenylsulfonium tetrafluoroborate

dimethylnaphthylsulfonium hexafluorophosphate

trifluoromethyldiphenylsulfonium tetrafluoroborate

p-(phenylthiophenyl)diphenylsulfonium hexafluoroantimonate

10-methylphenoxathiinium hexafluorophosphate

5-methylthianthrenium hexafluorophospnate

10-phenyl-9,9-dimethylthioxanthenium hexafluorophosphate

10-phenyl-9-oxothioxanthenium tetrafluoroborate

5-methyl-10-oxothianthrenium tetrafluoroborate

5-methyl-10,10-dioxothianthrenium hexafluorophosphate

Preferred sulfonium salts include triaryl-substituted salts such as triarylsulfonium hexafluoroantimonate (for example, SarCat™ SR1010 available from Sartomer Company), triarylsulfonium hexafluorophosphate (for example, SarCat™ SR 1011 available from Sartomer Company), and triarylsulfonium hexafluoroantimonate (for example, SarCat™ K185 available from Sartomer Company).

Useful azinium salts include those described in U.S. Pat. No. 4,859,572 (Farid et al.) at column 8, line 51, through column 9, line 46, which include an azinium moiety, such as a pyridinium, diazinium, or triazinium moiety. The azinium moiety can include one or more aromatic rings, typically carbocyclic aromatic rings (for example, quinolinium, isoquinolinium, benzodiazinium, and naphthodiazonium moieties), fused with an azinium ring. A quaternizing substituent of a nitrogen atom in the azinium ring can be released as a free radical upon electron transfer from the electronic excited state of the photosensitizer to the azinium photoinitiator. In one preferred form, the quaternizing substituent is an oxy substituent. The oxy substituent, —O-T, which quaternizes a ring nitrogen atom of the azinium moiety can be selected from among a variety of synthetically convenient oxy substituents. The moiety T can, for example, be an alkyl radical, such as methyl, ethyl, butyl, and so forth. The alkyl radical can be substituted. For example, aralkyl (for example, benzyl and phenethyl) and sulfoalkyl (for example, sulfomethyl) radicals can be useful. In another form, T can be an acyl radical, such as an —OC(O)—T¹ radical, where T¹ can be any of the various alkyl and aralkyl radicals described above. In addition, T¹ can be an aryl radical, such as phenyl or naphthyl. The aryl radical can in turn be substituted. For example, T¹ can be a tolyl or xylyl radical. T typically contains from 1 to about 18 carbon atoms, with alkyl moieties in each instance above preferably being lower alkyl moieties and aryl moieties in each instance preferably containing about 6 to about 10 carbon atoms. Highest activity levels have been realized when the oxy substituent, —O-T, contains 1 or 2 carbon atoms. The azinium nuclei need include no substituent other than the quaternizing substituent. However, the presence of other substituents is not detrimental to the activity of these photoinitiators.

Useful triarylimidazolyl dimers include those described in U.S. Pat. No. 4,963,471 (Trout et al.) at column 8, lines 18-28. These dimers include, for example, 2-(o-chlorophenyl)-4,5-bis(m-methoxyphenyl)-1,1′-biimidazole; 2,2′-bis(o-chlorophenyl)-4,4′,5,5′-tetraphenyl 1,1′-biimidazoe; and 2,5-bis(o-chlorophenyl)-4-[3,4-dimethoxyphenyl]-1,1′-biimidazole.

Preferred photoinitiators include iodonium salts (more preferably, aryliodonium salts), chloromethylated triazines, triarylimidazolyl dimers (more preferably, 2,4,5-triphenylimidazolyl dimers), sulfonium salts, and diazonium salts. More preferred are aryliodonium salts, chloromethylated triazines, and the 2,4,5-triphenylimidazolyl dimers (with aryliodonium salts and the triazines being most preferred).

Preparation of Photoreactive Composition

The reactive species, multiphoton photosensitizers, electron donor compounds, and photoinitiators can be prepared by the methods described above or by other methods known in the art, and many are commercially available. These four components can be combined under “safe light” conditions using any order and manner of combination (optionally, with stirring or agitation), although it is sometimes preferable (from a shelf life and thermal stability standpoint) to add the photoinitiator last (and after any heating step that is optionally used to facilitate dissolution of other components). Solvent can be used, if desired, provided that the solvent is chosen so as to not react appreciably with the components of the composition. Suitable solvents include, for example, acetone, dichloromethane, and acetonitrile. The reactive species itself can also sometimes serve as a solvent for the other components.

The components of the photoinitiator system are present in photochemically effective amounts (as defined above). Generally, the composition contains at least about 5%, preferably at least about 10%, and more preferably, at least about 20%, by weight of one or more reactive species. Generally, the composition contains up to about 99.79%, preferably up to about 95%, and more preferably up to about 80%, by weight of one or more reactive species. Generally, the composition contains at least about 0.01%, preferably at least about 0.1%, more preferably, at least about 0.2%, by weight of one or more photosensitizers. Generally, the composition contains up to about 10%, preferably up to about 5%, and more preferably up to about 2%, by weight of one or more photosensitizers. Preferably, the composition contains at least about 0.1% by weight of one or more electron donors. Preferably, the composition contains up to about 10%, and preferably up to about 5%, by weight of one or more electron donors. Preferably, the composition contains at least about 0.1% by weight of one or more photoinitiators. Preferably, the composition contains up to about 10%, and preferably up to about 5%, by weight of one or more photoinitiators. When the reactive species is a leuco dye, the composition generally can contain at least about 0.01%, preferably at least about 0.3%, more preferably at least about 1%, and most preferably at least about 2%, by weight of one or more leuco dyes. When the reactive species is a leuco dye, the composition generally can contain up to about 10% by weight of one or more leuco dyes. These percentages are based on the total weight of solids, i.e., the total weight of components other than solvent.

A wide variety of adjuvants can be included in the photoreactive compositions, depending upon the desired end use. Suitable adjuvants include solvents, diluents, resins, binders, plasticizers, pigments, dyes, inorganic or organic reinforcing or extending fillers (at preferred amounts of about 10% to 90% by weight based on the total weight of the composition), thixotropic agents, indicators, inhibitors, stabilizers, ultraviolet absorbers, medicaments (for example, leachable fluorides), and the like. The amounts and types of such adjuvants and their manner of addition to the compositions will be familiar to those skilled in the art.

It is within the scope of this invention to include nonreactive polymeric binders in the compositions in order, for example, to control viscosity and to provide film-forming properties. Such polymeric binders can generally be chosen to be compatible with the reactive species. For example, polymeric binders that are soluble in the same solvent that is used for the reactive species, and that are free of functional groups that can adversely affect the course of reaction of the reactive species, can be utilized. Binders can be of a molecular weight suitable to achieve desired film-forming properties and solution rheology (for example, molecular weights between about 5,000 and 1,000,000 daltons; preferably between about 10,000 and 500,000 daltons; more preferably, between about 15,000 and 250,000 daltons). Suitable polymeric binders include, for example, polystyrene, poly(methyl methacrylate), poly(styrene)-co-(acrylonitrile), cellulose acetate butyrate, and the like.

Prior to exposure, the resulting photoreactive compositions can be coated on a substrate, if desired, by any of a variety of coating methods known to those skilled in the art (including, for example, knife coating and spin coating). The substrate can be chosen from a wide variety of films, sheets, and other surfaces, depending upon the particular application and the method of exposure to be utilized. Preferred substrates are generally sufficiently flat to enable the preparation of a layer of photoreactive composition having a uniform thickness. For applications where coating is less desirable, the photoreactive compositions can alternatively be exposed in bulk form.

Exposure System and Its Use

Useful exposure systems include at least one light source (usually a pulsed laser) and at least one optical element. Suitable light sources include, for example, femtosecond near-infrared titanium sapphire oscillators (for example, a Coherent Mira Optima 900-F) pumped by an argon ion laser (for example, a Coherent Innova). This laser, operating at 76 MHz, has a pulse width of less than 200 femtoseconds, is tunable between 700 and 980 nm, and has average power up to 1.4 Watts. However, in practice, any light source that provides sufficient intensity (to effect multiphoton absorption) at a wavelength appropriate for the photosensitizer (used in the photoreactive composition) can be utilized. Such wavelengths can generally be in the range of about 300 nm to about 1500 nm; preferably, from about 600 nm to about 1100 nm; more preferably, from about 750 nm to about 850 nm. Peak intensities can generally range from at least about 10⁶ W/cm². The upper limit on the pulse fluence (energy per pulse per unit area) is generally dictated by the ablation threshold of the photoreactive composition. For example, Q-switched Nd:YAG lasers (for example, a Spectra-Physics Quanta-Ray PRO), visible wavelength dye lasers (for example, a Spectra-Physics Sirah pumped by a Spectra-Physics Quanta-Ray PRO), and Q-switched diode pumped lasers (for example, a Spectra-Physics FCbar™) can also be utilized. Preferred light sources are near infrared-pulsed lasers having a pulse length less than about 10 nanoseconds (more preferably, less than about 1 nanosecond; most preferably, less than about 10 picoseconds). Other pulse lengths can be used as long as the peak intensity and fluence criteria given above are met.

Optical elements useful in carrying out the method of the invention include refractive optical elements (for example, lenses and prisms), reflective optical elements (for example, retroreflectors or focusing mirrors), diffractive optical elements (for example, gratings, phase masks, and holograms), diffusers, Pockels cells, wave-guides, wave plates, birefringent liquid crystals, and the like. Such optical elements are useful for focusing, beam delivery, beam/mode shaping, pulse shaping, and pulse timing. Generally, combinations of optical elements can be utilized, and other appropriate combinations will be recognized by those skilled in the art. It is often desirable to use optics with large numerical aperture to provide highly-focused light. However, any combination of optical elements that provides a desired intensity profile (and spatial placement thereof) can be utilized. For example, the exposure system can include a scanning confocal microscope (BioRad MRC600) equipped with a 0.75 NA objective (Zeiss 20X Fluar).

Generally, exposure of the photoreactive composition can be carried out using a light source (as described above) along with an optical system as a means for controlling the three-dimensional spatial distribution of light intensity within the composition. For example, the light from a pulsed laser can be passed through a focusing lens in a manner such that the focal point is within the volume of the composition. The focal point can be scanned or translated in a three-dimensional pattern that corresponds to a desired shape, thereby creating the desired shape. The exposed or illuminated volume of the composition can be scanned either by moving the composition itself or by moving the light source (for example, moving a laser beam using galvo-mirrors).

If the light induces, for example, a reaction of the reactive species that produces a material having solubility characteristics different from those of the reactive species, the resulting image can optionally be developed by removing either the exposed or the unexposed regions through use of an appropriate solvent, for example, or by other art-known means. Complex, three-dimensional objects can be prepared in this manner.

Exposure times generally depend upon the type of exposure system used to cause image formation (and its accompanying variables such as numerical aperture, geometry of light intensity spatial distribution, the peak light intensity during the laser pulse (higher intensity and shorter pulse duration roughly correspond to peak light intensity)), as well as upon the nature of the composition exposed (and its concentrations of photosensitizer, photoinitiator, and electron donor compound). Generally, higher peak light intensity in the regions of focus allows shorter exposure times, everything else being equal. Linear imaging or “writing” speeds generally can be about 5 to 100,000 microns/second using a laser pulse duration of about 10⁻⁸ to 10⁻¹⁵ seconds (preferably, about 10⁻¹¹ to 10⁻¹⁴ second) and about 10² to 10⁹ pulses per second preferably, about 10³ to 10⁸ pulses per second).

### EXAMPLES

Objects and advantages of this invention are further illustrated by the following examples, but the particular materials and amounts thereof recited in these examples, as well as other conditions and details, should not be construed to unduly limit this invention. These examples discuss the use of optical elements to prepare three dimensional shapes within a photoreactive composition.

### Example 1

This example discusses the use of a phase or diffractive mask for forming photopolymerized regions by a multiphoton absorption process.

Calculations of the phase profile for the diffractive mask use an input beam having uniform energy distribution. For this example, to minimize the run time for the calculations, a simple square grid of lines, all in one plane, serves as the test pattern. Fabrication of the mask is through the use of conventional etching techniques, and this mask has four phase levels to provide diffraction efficiency.

The design of the phase mask yields a series of focal points or lines in one plane with a focal length of 10 millimeter (mm) and an effective numerical aperture of 0.50. The series of focal lines generated by the mask forms a grid of square geometry with line spacing in the x or y direction of 0.5 centimeter (cm). The writing laser is an amplified Ti:Sapphire laser delivering 750 milliwatt (mW) at 800 nanometers (nm) at 1 kilohertz (kHz) with a pulse width of 120 femptosecond (fs). The TEM₀₀ output from the laser enters an optical system transforming the input gaussian beam into a uniform energy distribution with a rectangular cross section of 0.1 cm by 10.1 cm. The fluence per pulse at the plane of the phase mask is 0.74 millijoules per square centimeter (mJ/cm²). The phase mask attaches to a holding fixture spacing the bottom of the mask approximately 9.5 mm above the sample surface. Micrometer adjustments of the mask mount bring the final focal position to coincide with the top surface of a sample. The mask mount and sample stage move in registration with each other. The rectangular beam from the laser impinges the mask perpendicular to the plane of the mask, with the long axis of the beam parallel to the short axis of the mask. The laser beam is stationary relative to the stage and mask motion.

A test sample, consisting of an 8 mm thick, 12.7 cm diameter polished glass wafer having an average surface roughness of 0.1 micrometer (μm), provides a base for the polymer coating. A thin layer of methyl methacrylate monomer with a 1% loading of 4,4′-bis(diphenylamino)-trans-stilbene, a multiphoton initiator, covers the polished side of the glass wafer. The composition of this polymerizable coating consists of solids component of 40% tris-(2-hydroxyethelyene) isocyanurate triacrylate ester, 50% methyl methacrylate, and 1% multiphoton absorber dissolved to 40% by weight concentration in dioxane. This layer of polymerizable material is approximately 100 μm thick. Exposure of the polymerizable coating on the covered glass wafer occurs by continuously moving the phase mask and sample construction along a direction parallel to the short axis of the rectangular beam exiting the optical system. The sample stage moves uniformly at a speed of 100 μm/second past the light source. As the light source scans the phase mask, a grid of lines is photopolymerized in the polymerizable layer.

Developing the PMMA coating in dioxane removes the unreacted regions from the glass wafer revealing reacted (e.g., photocured) lines in the form of a square grid. The individual lines forming the grid have thicknesses of approximately 20 μm and widths of approximately 15 μM. The polymeric lines have good adhesion to the glass wafer.

### Examples 2-6

In these examples a variety of different arrays of optical element arrays were used to produce, in a single exposure pass, multiple regions of at least partially reacted material by multiphoton photopolymerization. Unless otherwise noted, the chemicals used were commercially available from Aldrich Chemical Co. Milwaukee, Wis.

The two-photon sensitizing dye, Bis-[4-(diphenylamino)stryl]-1,4-(dimethoxy)benzene was prepared as follows: (1) Reaction of 1,4-bis-bromomethyl-Z 5-dimethoxybenzene with triethyl phosphite (Horner Eamons reagent): 1,4-bis-bromomethyl-2,5-dimethoxybenzene was prepared according to the literature procedure (Syper et. al., Tetrahedron, 1983, 39, 781-792). 1,4-bis-bromomethyl-2,5-dimethoxybenzene (253 g, 0.78 mol) was placed into a 1000-mL round bottom flask. Triethyl phosphite (300 g, 2.10 mol) was added. The reaction was heated to vigorous reflux with stirring for 48 hours under nitrogen atmosphere. The reaction mixture was cooled and the excess P(OEt)₃ was removed under vacuum using a Kugelrohr apparatus. The desired product was not actually distilled, but the Kugelrohr was used to remove the excess P(OEt)₃ by distilling it away from the product. Upon heating to 100° C. at 0.1 mmHg, a clear oil resulted. Upon cooling the desired product solidified. The product was suitable for use directly in the next step, and ¹H NMR was consistent with the proposed structure. Recrystallization from toluene yielded colorless needles and resulted in a purer product, but this was not necessary for subsequent steps in most cases.

(2) Synthesis of Bis-[4-(diphenylamino)stryl]-1,4-(dimethoxy)benzene: A 1000-mL round bottom flask was fitted with a calibrated dropping funnel and a magnetic stirrer. The flask was charged with the product from the above synthesis (a Horner Eamons reagent) (19.8 g, 45.2 mol), and it was also charged with N,N-diphenylamino-p-benzaldehyde (Fluka, 25 g, 91.5 mmol). The flask was flushed with nitrogen and sealed with septa. Anhydrous tetrahydrofuran (750 mL) was cannulated into the flask and all solids dissolved. The dropping funnel was charged with KOtBu potassium t-butoxide) (125 mL, 1.0 M in THF). The solution in the flask was stirred and the KOtBu solution was added to the contents of the flask over the course of 30 minutes. The solution was then left to stir at ambient temperature overnight. The reaction was then quenched by the addition of H₂O (500 mL). The reaction continued to stir and after about 30 minutes a highly fluorescent yellow solid had formed in the flask. The solid was isolated by filtration and air-dried. It was then recrystallized from toluene (450 mL). The desired product was obtained as fluorescent needles (24.7 g, 81% yield). ¹H NMR was consistent with the proposed structure.

The light source for Examples 2-5 was a diode pumped Ti:sapphire laser (Spectra-Physics) operating at a wavelength of 800 nm, pulse width of approximately 100 fs, pulse repetition rate of 80 MHz, beam diameter of approximately 2 mm, and an average output power of 860 mW. The optical train consisted of low dispersion turning mirrors and an optical attenuator to vary the optical power. The final focusing element was discussed in detail for each example. Movement of the sample, or sample and final focusing element, was accomplished using New England Affiliated Technologies, Inc. (Lawrence, Mass.) motorized, computer controlled stages.

TABLE 1
Photoreactive Composition I

| Ingredient | Weight % |
|---|---|
| Poly(methylmethacrylate) (MW approximately 120,000 g/ | 26.55 |
| mol) | |
| Tris(2-hydroxyethylene)isocyanurate triacrylate SR-368 | 35.40 |
| (Sartomer Co., West Chester, PA) | |
| Alkoxylated trifunctional acrylate SR-9008 (Sartomer Co., | 35.40 |
| West Chester, PA) | |
| CGI 7460 (Ciba Specialty Chemicals, Tarrytown, NY) | 1.77 |
| Diaryliodonium hexafluorophosphate, SR1012 (Sartomer Co., | 1.77 |
| West Chester, PA) | |
| Bis-[4-(diphenylamino)stryl]-1,4-(dimethoxy)benzene | 0.88 |

### Example 2

In Example 2, an array of fused silica microlenses (commercially available from MEMS Optical of Huntsville, Ala.) was used to divide the collimated beam into multiple focused spots in the volume of the sample. The microlenses were arranged in a hexagonal array and had a fill-factor of 70%.

Each micro-lens was approximately 76 microns in diameter and has numerical aperture of 0.5. For these test substrates, reacting (e.g., photocuring) was accomplished by positioning the lens array on 70 μm thick shims above that substrate such that the focal position of each microlens approximately coincided with the substrate/polymer interface (see FIG. 1a).

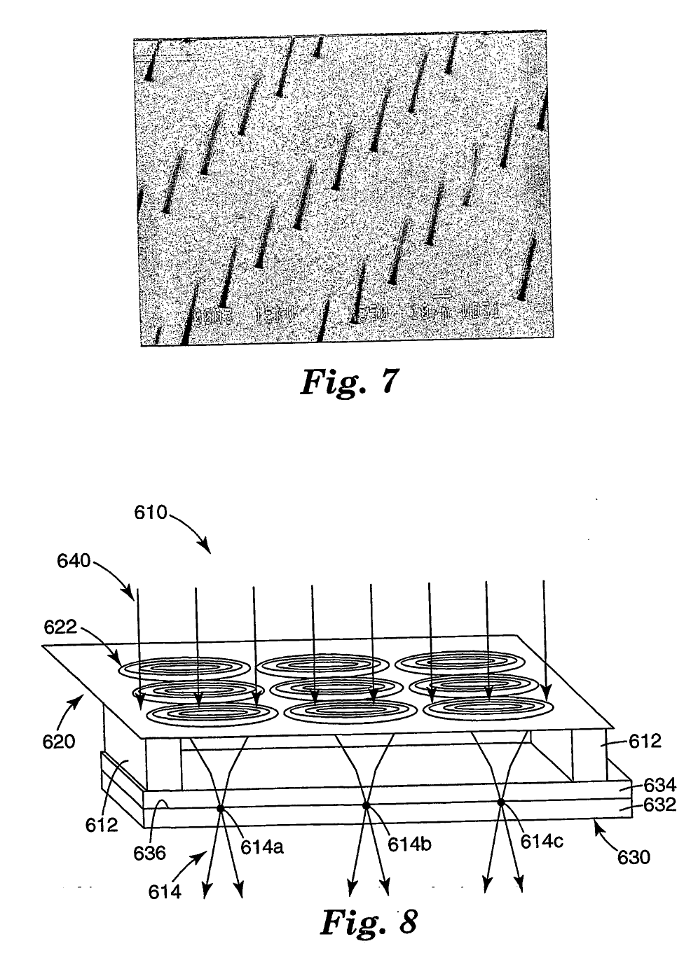

The test samples consisted of glass microscope slides, previously treated with a 2% solution of trimethoxysilylpropylmethacrylate in aqueous ethanol as adhesion promoter, and then spin coated with photoreactive composition I (Table 1) dissolved in 46% solids solution in dioxane (Mallinckrodt Baker Inc., Phillipsburg, N.J.). The coated slides were then baked in an 80° C. oven for 10 minutes to remove the solvent. The final film thickness was approximately 30 μm. The lens array ((30, FIG. 1a) and test sample (20, FIG. 1a) were scanned together at 125 μm/second under the collimated laser beam (average power of 650 mW) to expose an area of 0.1 cm² in 40 seconds (s). The exposed sample was developed using N,N-dimethylformamide, rinsed in isopropyl alcohol and air dried. FIG. 7 shows a scanning electron micrograph of the structures that resulted under the test conditions of Example 2. A pattern of reacted polymer posts corresponding to the spacing and symmetry of the microlens array was formed everywhere the laser beam was scanned over the array.

In Examples 3 through 5, a square array of diffractive lenses in acrylic was used to divide the collimated beam into multiple focussed spots. The lens pitch was 1.0 mm in both horizontal and vertical directions with 100% fill factor. Each lens was a 2-wave design, multi-level diffractive element, with design focal length of 10.0 mm at 633 nm.

### Example 3

The apparatus utilized for Example 3 is illustrated in FIG. 8. As depicted, an exposure system 610 included an array of diffractive lenses 620 held on shims 612 and 614 above a substrate 630. The array 620 included diffractive lenses 622, which focused incident light 640 at focal points 614 (i.e., 614a-614c). The substrate 630 included a microscope slide 632 and a photoreactive composition layer 634 that was coated on the slide 632 at interface 636. The position of the array 630 was adjusted so that the focal points 614 of the diffractive lenses 622 approximately coincided with the substrate/polymer interface 636. The laser beam size was expanded by approximately 5× using a Galilean telescope set-up so as to fill completely at least four of the diffractive lenses 622. Both the diffractive lens array 620 and the test sample 630 were scanned together at 125 μm/s under the collimated, expanded, laser beam (average power of 230 mW). Test samples identical to that described in Example 2 were prepared, exposed, developed in N,N-dimethylformamide, rinsed with isopropyl alcohol, and air dried.

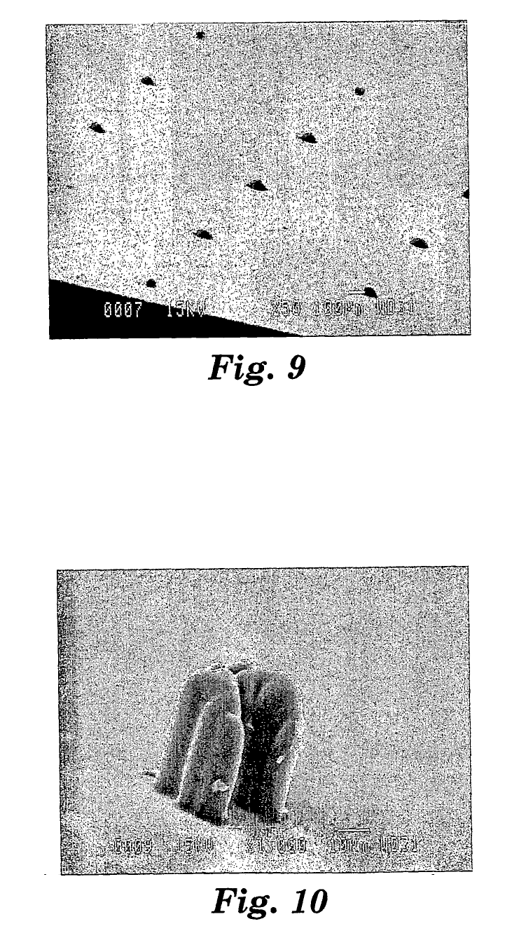

FIGS. 9 and 10 show scanning electron micrographs of the structures that resulted under the imaging conditions of Example 3. A pattern of reacted polymer posts and mounds corresponding to the spacing and symmetry of the diffractive lens array are visible. The shape of the individual posts were more irregular than in Example 2, indicating the more complicated focusing properties of the array 620.

### Example 4

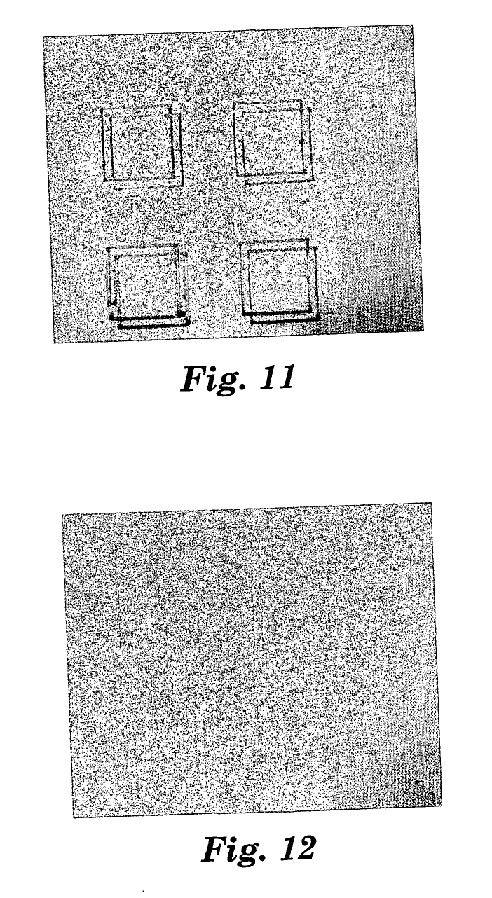

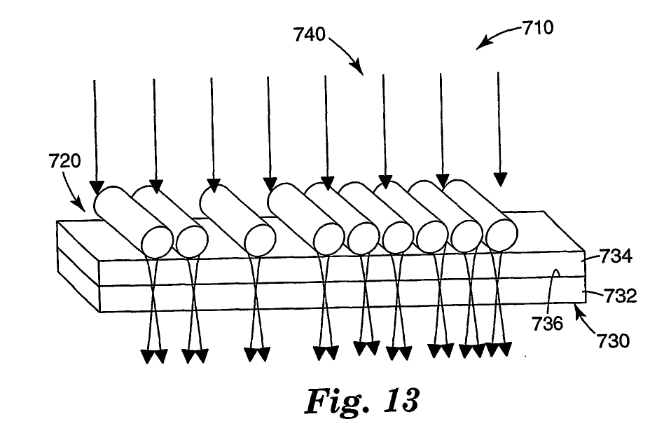

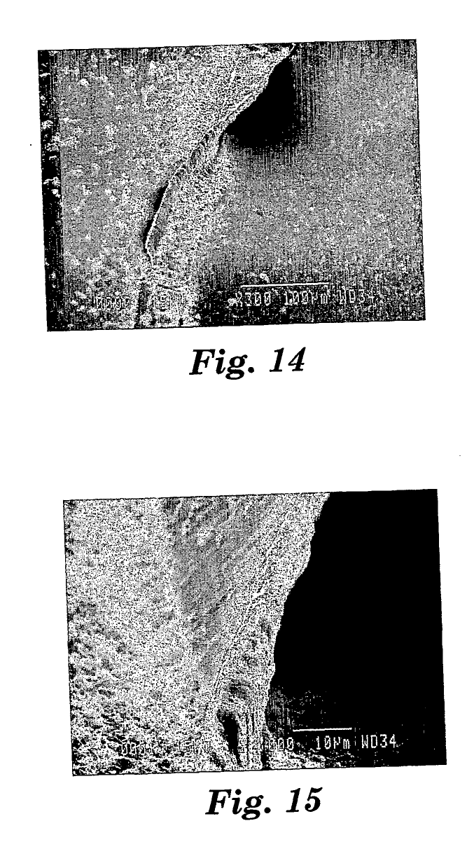

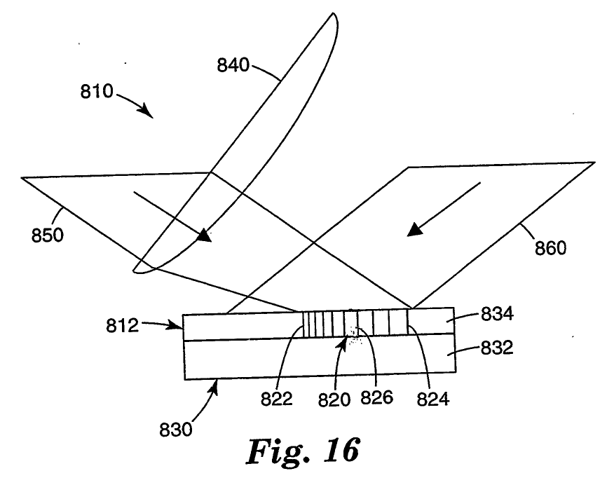

In Example 4, the square array of diffractive lenses was held fixed with respect to the laser beam and the substrate was scanned underneath. This optical configuration allowed production of arbitrary patterns at multiple imaging spots. The laser beam size was expanded by approximately 5× using a Galilean telescope set-up so as to completely fill at least four of the diffractive lenses and the position of the zone plate adjusted so that the focal point approximately coincided with the substrate/polymer interface (see, e.g., FIG. 8). While any arbitrary test pattern could be written using this optical configuration, for this example the stages were programmed to produce a test pattern of two interlaced squares. Test samples identical to that in Example 2 were prepared and exposed by scanning the substrate underneath the array at 125 μm/s (230 mW average laser power). The samples were then developed in N,N-dimethylformamide, rinsed with isopropyl alcohol, and air dried. FIG. 11 shows an optical micrograph of the structures that resulted under the imaging conditions of Example 4. The test pattern was reproduced at the focus of each of 4 different imaging spots. The polymer had good adhesion to the substrate.

### Example 5

In Example 5, imaging using patterned light of a hybrid polymer system was demonstrated. The hybrid polymer system consisted of reactive monomers in a thermoplastic matrix. The refractive index and density of the photoreactive composition was increased in the illuminated areas as a result of polymerization and subsequent monomer diffusion into the illuminated area. After the desired structures have been created, the entire film may be blanket exposed using a one-photon source to permanently fix the image.

The photoreactive composition of Table 2 was prepared as an approximately 40% solids solution in 1,2-dichloroethane and spun coated on to microscope slides. The coated slides were then baked in an 80° C. oven for 10 minutes to remove the solvent (final film thickness was approximately 30 μm). The same optical configuration and test pattern as in Example 4 were used. The substrate was scanned under the beam at 125 μm/s (average power of 230 mW). Following imaging, the test samples were blanket non-image wise exposed using a bank of 3 Phillips TLD 3W lights for 45 minutes to fix the image.

FIG. 12 shows an optical micrograph of the refractive index contrast image. The test pattern was reproduced at the focus of each of the different imaging spots.

TABLE 2
Photoreactive composition for Example 5

| Ingredient | Weight % |
|---|---|
| Cellulose acetate butyrate CAB-531-1 (Eastman Chemicals, | 49.99 |
| Kingsport, TN) | |
| Phenoxyethyl acrylate SR-339 (Sartomer Co., West Chester, | 38.75 |
| PA) | |
| 2-(1-Naphthoxy)ethyl acrylate* | 5.53 |
| SR-351 (Sartomer Co., West Chester, PA) | 0.92 |
| Bis-[4-(diphenylamino)stryl]-1,4-(dimethoxy)benzene | 0.96 |
| CGI 7460 (Ciba Specialty Chemicals, Tarrytown, NY) | 1.92 |
| Diaryliodonium hexafluorophosphate, SR1012 (Sartomer Co., | 1.92 |
| West Chester, PA) | |

2-(1-Naphthoxy)ethyl acrylate, was made as described in U.S. patent application Ser. No. 09/746,613, filed on Dec. 21, 2000.

### Example 6

FIG. 13 illustrates an exposure system 710 used in Example 6. Pieces of Corning SMF-28 single mode optical fiber were used as an linear array of cylindrical lenses 720 for imaging. Test substrates 730 identical to that of Example 2 were prepared. The optical fiber was stripped of its outer coating using a fiber stripper, cleaned with solvent, and then lightly pressed on to the top face of the unreacted test sample 730 as shown in FIG. 13. The substrate 730 was then raster scanned at 250 μm/s underneath a collimated laser beam 740 (average laser power was 640 mW). The Y-stage was moved by approximately half the beam diameter in each pass. Following imaging, the test samples were developed in N,N-dimethylformamide, rinsed with isopropyl alcohol, and air dried. FIGS. 14 and 15 show scanning of the resulting high aspect ratio polymer lines that were produced.

### Example 7

As illustrated in FIG. 16, a chirped grating 812 (e.g., a grating where the spacing between lines becomes smaller with each successive fringe) having an interference pattern 820 is formed in a photoreactive composition 834 by use of the interference fringe pattern created by the combination of a plane wave 860 and a cylindrical wave 850. Straight interference fringes are formed in a single plane by the combination of two plane waves (having propagation directions which are neither parallel nor antiparallel) and which are incident upon the image plane. Parallel interference fringes 826 having a chirped period are formed by placing a cylindrical lens 840 in the path of one beam (with the uniform axis of the lens 840 parallel to the interference fringes 826 from the original configuration). This technique is well known in the art associated with the manufacture of fiber bragg gratings (for example, see R. Kashyap, Fiber Bragg Gratings, Academic Press, 1999). As can be seen in FIG. 16, the fringe period at a left edge 822 of the grating 820 is smaller than the case without the cylindrical lens (as a result of the increased incidence angle). The period at a right edge 824 of the grating is unaffected. The chirp rate of the interference pattern 820 can be controlled by changing either the focal length of the cylindrical lens 840 and/or changing the distance between the lens 840 and the plane of interference and/or placing a cylindrical lens (of similar orientation) in the second beam 860.

The short pulses used in a multiphoton absorption exposure system cause small portions of the interference pattern to be reacted during each laser pulse. Therefore, precise matching of the pathlength of both beams 850 and 860 allows the overlap of the pulses to form selected regions of the three-dimensional interference pattern 820. This pathlength-matching is accomplished by passing beams 850 and 860 through separate optical delay lines (described in Kirkpatrick, et al., Appl. Phys. A, 69, 461). By careful adjustment of each of the beam pathlengths with respect to the others it is therefore possible to react different portions of the chirped interference pattern 820 with successive laser pulses.

### Example 8

This example discusses the use of 3-beam interference to form multiple photopolymerized regions by a multiphoton absorption process. It is well known that interference of two coherent light beams in space and time produce a pattern of high and low intensity fringes where the periodicity depends on the angle between the incoming beams. In this example, interference of three coherent, pulsed laser beams is used to define a 2-dimensional array of bright and dark regions that is used to produce the corresponding 2-dimensional array of photopolymerized regions in a single image plane.

The writing laser is an amplified Ti:sapphire laser delivering 800 mW at 800 nm at 1 kHz with a pulse width of 120 fs. The TEM₀₀ output from the laser is passed through two beam splitters to generate 3 independent beams of approximately equal intensity. The optical trains for two of the beams include independent optical delay lines as well as a glass wedge in a rotating optical mount. By turning the mount, the optical path length can be finely adjusted. The beams are recombined at the sample as shown in FIG. 5 so that the angle between each of the beams is approximately 120 degrees. For the purposes of optical alignment, only the first two beams (one with a delay line, one without) are allowed to interfere. The length of the optical delay line is adjusted until the pulses from the first two beams overlap in space and time as indicated by observation of a sharp increase in the intensity of the two-photon fluorescence and a fringe interference pattern. The third beam is then introduced and again the length of its optical delay is adjusted until there is a sharp increase in the intensity of the two-photon fluorescence and an interference pattern is observed.

A solution (40% solids in 1,2-dichloroethane) containing 40% weight cellulose acetate butyrate (n is approximately 1.46, Eastman Chemicals, Kingsport, Tenn.), 23% by weight phenoxyethylacrylate (Sartmer Company, West Chester, Pa.), 34% by weight bisphenol A glycerolate diacrylate (Ebecryl 3700, UCB Chemicals, Symra, Ga.), 2% by weight diaryliodonium salt (Sartomer Company, West Chester, Pa.), and 1% by weight bis-[4-(diphenylamino)styryl]-1,4-(dimethoxy)benzene is prepared. The solution is coated on to a silicon wafer approximately 100 microns thick and dried in an oven at 80° C. The test sample is positioned so that the three beams interfere within the volume of the coating and exposed resulting in a 2-dimensional hexagonal honeycomb pattern in a single image plane. The refractive index modulation of the reacted regions is at least 0.005 relative to the subsequently reacted matrix. The coating is then blanket-exposed in a non-imagewise manner using a bank of 3 Philips TLD 3W-05 bulbs with primary output at 450 nm for 30 minutes. The film maintains refractive index modulation of at least 0.005 relative to the patterned regions.

The complete disclosures of the patents, patent documents, and publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

What is claimed is:

1. A method for producing a region of at least partially reacted material in a photoreactive composition, the method comprising:
providing a photoreactive composition;
providing a source of sufficient light for simultaneous absorption of at least two photons by the photoreactive composition;
providing an exposure system comprising at least one diffractive optical element, wherein the exposure system is capable of inducing image-wise multiphoton absorption;
generating a non-random three-dimensional pattern of light by means of the exposure system; and
exposing the photoreactive composition to the three-dimensional pattern of light generated by the exposure system to at least partially react a portion of the material in correspondence with the non-random three-dimensional pattern of light incident thereon.

2. The method of claim 1 wherein exposing comprises pulse irradiating.

3. The method of claim 2 wherein the pulse irradiating is carried out using a near infrared pulsed laser having a pulse length less than about 10 nanoseconds.

4. The method of claim 1 wherein the diffractive optical element is a diffrative mask.

5. The method of claim 1 wherein the photoreactive composition comprises about 5% to about 99.79% by weight of the at least one reactive species, about 0.01% to about 10% by weight of the at least one multiphoton photosensitizer, up to about 10% by weight of the at least one electron donor compound, and about 0.1% to about 10% by weight of the at least one photoinitiator, based upon the total weight of solids.

6. The method of claim 1 wherein the diffractive optical element is capable of beamsplitting, wavefront transformation, or both.

7. A method for producing a region of at least partially reacted material in a photoreactive composition, the method comprising:
providing a photoreactive composition;
providing a source of sufficient light for simultaneous absorption of at least two photons by the photoreactive composition;
providing an exposure system comprising at least one array of refractive micro-optical elements, wherein the exposure system is capable of inducing image-wise multiphoton absorption;
generating a non-random three-dimensional pattern of light by means of the exposure system; and
exposing the photoreactive composition to the three-dimensional pattern of light generated by the exposure system to at least partially react a portion of the material in correspondence with the non-random three-dimensional pattern of light incident thereon.

8. The method of claim 7 wherein exposing comprises pulse irradiating.

9. The method of claim 8 wherein the pulse irradiating is carried out using a near infrared pulsed laser having a pulse length less than about 10 nanoseconds.

10. The method of claim 7 wherein the array of refractive micro-optical element comprises an array of optical fibers.

11. The method of claim 7 wherein the photoreactive composition comprises about 5% to about 99.79% by weight of the at least one reactive species, about 0.01% to about 10% by weight of the at least one multiphoton photosensitizer, up to about 10% by weight of the at least one electron donor compound, and about 0.1% to about 10% by weight of the at least one photoinitiator, based upon the total weight of solids.

12. A method for producing a region of at least partially reacted material in a photoreactive composition, the method comprising:
providing a photoreactive composition;
providing a source of sufficient light for simultaneous absorption of at least two photons by the photoreactive composition;
providing an exposure system capable of inducing image-wise multiphoton absorption, the exposure system comprising:
a first beam of light comprising a first wavefront shape; and
a second beam of light comprising a second wavefront shape, wherein the first wavefront shape is substantially different from the second wavefront shape;
generating a non-random three-dimensional pattern of light by means of the exposure system using optical interference between the first beam of light and the second beam of light; and
exposing the photoreactive composition to the three-dimensional pattern of light generated by the exposure system to at least partially react a portion of the material in correspondence with the non-random three-dimensional pattern of light incident thereon.

13. The method of claim 12 wherein exposing comprises pulse irradiating.

14. The method of claim 13 wherein the pulse irradiating is carried out using a near infrared pulsed laser having a pulse length less than about 10 nanoseconds.

15. The method of claim 12 wherein the light source comprises a pulsed laser.

16. The method of claim 12 wherein the photoreactive composition comprises about 5% to about 99.79% by weight of the at least one reactive species, about 0.01% to about 10% by weight of the at least one multiphoton photosensitizer, up to about 10% by weight of the at least one electron donor compound, and about 0.1% to about 10% by weight of the at least one photoinitiator, based upon the total weight of solids.

17. A method for producing a region of at least partially reacted material in a photoreactive composition, the method comprising:
providing a photoreactive composition;
providing a source of sufficient light for simultaneous absorption of at least two photons by the photoreactive composition;
providing an exposure system capable of inducing image-wise multiphoton absorption, the exposure system comprising three or more light beams, wherein each light beam of the three or more light beams comprise a wavefront having a shape, and further wherein each light beam of the three or more light beams has a wavefront shape that is the same or substantially different from the wavefront shape of the other light beams;
generating a non-random three-dimensional pattern of light by means of the exposure system using optical interference from the three or more light beams; and
exposing the photoreactive composition to the three-dimensional pattern of light generated by the exposure system to at least partially react a portion of the material in correspondence with the non-random three-dimensional pattern of light incident thereon.

18. The method of claim 17 wherein exposing comprises pulse irradiating.

19. The method of claim 18 wherein the pulse irradiating is carried out using a near infrared pulsed laser having a pulse length less than about 10 nanoseconds.

20. The method of claim 17 wherein the light source comprises a pulsed laser.

21. The method of claim 17 wherein the photoreactive composition comprises about 5% to about 99.79% by weight of the at least one reactive species, about 0.01% to about 10% by weight of the at least one multiphoton photosensitizer, up to about 10% by weight of the at least one electron donor compound, and about 0.1% to about 10% by weight of the at least one photoinitiator, based upon the total weight of solids.

22. An apparatus for reacting a photoreactive composition, comprising:
a photoreactive composition;
a source of sufficient light for simultaneous absorption of at least two photons by the photoreactive composition;
an exposure system comprising at least one diffractive optical element, wherein the exposure system is capable of inducing image-wise multiphoton absorption, wherein the exposure system is capable of generating a non-random three-dimensional pattern of light, and further wherein the exposure system is capable of at least partially reacting a portion of the material in correspondence with the non-random three-dimensional pattern of light.

23. The apparatus of claim 22 wherein the light source comprises a pulsed laser.

24. The apparatus of claim 22 wherein the photoreactive composition comprises about 5% to about 99.79% by weight of the at least one reactive species, about 0.01% to about 10% by weight of the at least one multiphoton photosensitizer, up to about 10% by weight of the at least one electron donor compound, and about 0.1% to about 10% by weight of the at least one photoinitiator, based upon the total weight of solids.

25. The apparatus of claim 22 wherein the diffractive optical element is capable of beamsplitting, wavefront transformation, or both.

26. The apparatus of claim 22 wherein the diffractive optical element is a diffrative mask.

27. An apparatus for reacting a photoreactive composition, comprising:
a photoreactive composition;
a source of sufficient light for simultaneous absorption of at least two photons by the photoreactive composition;
an exposure system comprising at least one array of refractive micro-optical elements, wherein the exposure system is capable of inducing image-wise multiphoton absorption, wherein the exposure system is capable of generating a non-random three-dimensional pattern of light, and further wherein the exposure system is capable of at least partially reacting a portion of the material in correspondence with the non-random three-dimensional pattern of light.

28. The apparatus of claim 27 wherein the light source comprises a pulsed laser.

29. The apparatus of claim 27 wherein the photoreactive composition comprises about 5% to about 99.79% by weight of the at least one reactive species, about 0.01% to about 10% by weight of the at least one multiphoton photosensitizer, up to about 10% by weight of the at least one electron donor compound, and about 0.1% to about 10% by weight of the at least one photoinitiator, based upon the total weight of solids.

30. The apparatus of claim 27 wherein the array of refractive micro-optical element comprises an array of optical fibers.

31. An apparatus for reacting a photoreactive composition, comprising:
a photoreactive composition;
a source of sufficient light for simultaneous absorption of at least two photons by the photoreactive composition;
an exposure system comprising a first beam of light comprising a first wavefront shape and a second beam of light comprising a second wavefront shape, wherein the first wavefront shape is substantially different than the second wavefront shape, wherein the exposure system is capable of inducing image-wise multiphoton absorption, wherein the exposure system is capable of generating a non-random three-dimensional pattern of light, and further wherein the exposure system is capable of at least partially reacting a portion of the material in correspondence with the non-random three-dimensional pattern of light.

32. The apparatus of claim 31 wherein the light source comprises a pulsed laser.

33. The apparatus of claim 31 wherein the photoreactive composition comprises about 5% to about 99.79% by weight of the at least one reactive species, about 0.01% to about 10% by weight of the at least one multiphoton photosensitizer, up to about 10% by weight of the at least one electron donor compound, and about 0.1% to about 10% by weight of the at least one photoinitiator, based upon the total weight of solids.

34. An apparatus for reacting a photoreactive composition, comprising:
a photoreactive composition;
a source of sufficient light for simultaneous absorption of at least two photons by the photoreactive composition;
an exposure system comprising three or more light beams, wherein each light beam of the three or more light beams comprises a wavefront having a shape, wherein each light beam of the three or more light beams has a wavefront shape that is the same or substantially different than the wavefront shape of the other light beams, wherein the exposure system is capable of inducing image-wise multiphoton absorption, wherein the exposure system is capable of generating a non-random three-dimensional pattern of light, and further wherein the exposure system is capable of at least partially a portion of the material in correspondence with the non-random three-dimensional pattern of light.

35. The apparatus of claim 34 wherein the photoreactive composition comprises about 5% to about 99.79% by weight of the at least one reactive species, about 0.01% to about 10% by weight of the at least one multiphoton photosensitizer, up to about 10% by weight of the at least one electron donor compound, and about 0.1% to about 10% by weight of the at least one photoinitiator, based upon the total weight of solids.
